(19) United States
(12) Patent Application Publication
(10) Pub. No.: US 2017/0186334 A1
(43) Pub. Date: Jun. 29, 2017

(54) SYSTEM AND METHOD FOR ENABLING A USER TO IMPROVE ON BEHAVIORAL TRAITS THAT ARE REQUIRED FOR ACHIEVING SUCCESS

(71) Applicants: Jonnalagadda SASIDHAR, Sleepy Hollow, NY (US); Pranav Kumar MISHRA, Burdwan (IN); Gopi Ambikapathi AMBEKAR, Bangalore (IN); Sreenidhi SUNDARAN, Bangalore (IN)

(72) Inventors: Jonnalagadda SASIDHAR, Sleepy Hollow, NY (US); Pranav Kumar MISHRA, Burdwan (IN); Gopi Ambikapathi AMBEKAR, Bangalore (IN); Sreenidhi SUNDARAN, Bangalore (IN)

(73) Assignee: DHARMA LIFE SCIENCES LLC, Sleepy Hollow, NY (US)

(21) Appl. No.: 15/455,159

(22) Filed: Mar. 10, 2017

Related U.S. Application Data
(63) Continuation-in-part of application No. 14/931,868, filed on Nov. 4, 2015.

(51) Int. Cl. G09B 19/00; G09B 5/02

(52) U.S. Cl. CPC G09B 19/00; G09B 5/02

(57) ABSTRACT

A system for enabling a user to improve on behavioral traits that are required for achieving success is provided. The system includes an activity module, which enables the user to engage in activities in a virtual environment, wherein the activities affect wirings of the brain, whose symptom is at least one positive behavioral trait that is required for success. The activity module enables the user to engage in mind actions, wherein the mind actions affect the wirings of the brain, whose symptom is the behavioral trait required for success. The activity module provides automated instructions to the user to engage in at least one activity, wherein the one activity is performed in a real-world environment, wherein the activity affects the wirings of the brain, wherein the activity is performed upon participating in the mind action to a desired extent.

### CROSS REFERENCE TO RELATED APPLICATION

This application is a continuation-in-part application of U.S. patent application Ser. No. 14/931,868 filed Nov. 4, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

### FIELD

The subject matter in general relates to behavioral traits in humans, and more particularly but not exclusively, the subject matter is directed to a technical solution to be better at a trait or to improve on a trait.

An individual's behavior towards others, attitudes, and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development.

One of the approaches used for determining the personality of a person is by way of taking a psychology based personality test. In such a test, the person answers a set of questions, and based on the answers gets a report detailing the type of personality that person may have, and whether he has the traits required for success.

Negative or weak traits in a person can lead to difficulty in achieving their life goals. Overcoming negative or weak traits makes one's life smoother by removing hurdles by bringing it from negative to average. Success, on the other hand, may be achieved by improving a set of traits which are required for success. Overcoming the negative traits may not be enough, to lead to success. An individual may have to work on a list of success traits depending on what is important to his profession as well as what he needs most improvement in. The set of traits which are required for success take an individual one step further by accelerating the rate of achieving success.

Conventionally, people try to improvise on the traits that are required for success by understanding traits they need to improve on to achieve their goals. To improve one's personality or personality trait that is required for success, an individual may visit a professional coach and/or attend personality development sessions. Coaching or personality development sessions may deal with the individual's trait via a broad based general (not focused at the root of the trait) approach, which may be effective in the short run. For example, if a person needs to be more passionate, the person may be advised to listen to a motivational speaker, engage socially with others in his field, be more optimistic and so on, which may prove effective to an extent for the time being.

Currently, there are multiple games and applications being developed that may work in the same way as a coaching process. Even these games deal with the trait via a general approach. Such approach may be effective in the short run but does not address success traits in a wholesome manner.

In light of the foregoing discussion there is a need for an improved technique to improve positive traits required for achieving success.

### SUMMARY

An embodiment provides a system for enabling a user to improve on behavioral traits that are required for achieving success is provided. The system includes an activity module, configured to receive input indicating the desire to improve at least one positive behavioral trait that enables a user to achieve success. The activity module enables the user to engage in activities in a virtual environment, wherein the activities affect wirings of the brain, whose symptom is at least one positive behavioral trait that is required for success. The activity module enables the user to engage in mind actions, wherein the mind actions affect the wirings of the brain, whose symptom is the behavioral trait required for success. The activity module provides automated instructions to the user to engage in at least one activity, wherein the one activity is performed in a real-world environment, wherein the activity affects the wirings of the brain, wherein the activity is performed upon participating in the mind action to a desired extent.

Another embodiment provides method for enabling a user to improve on behavioral traits that are required for achieving success. The method includes enabling the user to engage in one or more activities in a virtual environment, wherein the one or more activities affect one or more wirings of the brain, whose symptom is a positive behavioral trait that is required for achieving success. The method includes enabling the user to engage in at least one or more mind actions in a real-world environment, wherein the mind actions affect the one or more wirings of the brain, whose symptom is a behavioral trait that is required for achieving success, wherein engagement in the mind actions is enabled after the user has at least participated in the activities in the virtual world. The method further includes providing automated instructions to the user to engage in at least one activity, wherein the one activity is performed in a real-world environment, wherein the activity affects the one or more wirings of the brain.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 to improve behavioral traits required for achieving success;

FIG. 2 is a block diagram of an exemplary activity module 200 to improve behavioral traits required for achieving success;

FIG. 2A is a block diagram of an exemplary behavioral traits database 202 of the activity module 200;

FIG. 2B is a block diagram illustrating creativity 216 as the behavioral trait 214 and its associated information 226;

FIG. 2C is a block diagram illustrating ability to network 218 as the behavioral trait 214, and its associated information 226;

FIG. 2D is a block diagram illustrating open-mindedness 220 as the behavioral trait 214, and its associated information 226;

FIG. 2E is a block diagram illustrating passion 222 as the behavioral trait 214, and its associated information 226;

FIG. 2F is a block diagram illustrating ability to take risk 224 as the behavioral trait 214, and its associated information 226;

FIG. 3A is a block diagram of an exemplary collection of games 204 with respect to creativity 216, present in the activity module 200;

FIG. 3B is a block diagram of an exemplary collection of games 204 with respect to ability to network 218, present in the activity module 200;

FIG. 3C is a block diagram of an exemplary collection of games 204 with respect to open-mindedness 220, present in the activity module 200;

FIG. 3D is a block diagram of an exemplary collection of games 204 with respect to passion 222, present in the activity module 200;

FIG. 3E is a block diagram of an exemplary collection of games 204 with respect to ability to take risk 224, present in the activity module 200;

FIG. 4A is a block diagram of an exemplary mind actions database 205, with respect to creativity 216 of the activity module 200;

FIG. 4B is a block diagram of an exemplary mind actions database 205, with respect to ability to network 218 of the activity module 200;

FIG. 4C is a block diagram of an exemplary mind actions database 205, with respect to open-mindedness 220 of the activity module 200;

FIG. 4D is a block diagram of an exemplary mind actions database 205, with respect to passion 222 of the activity module 200;

FIG. 4E is a block diagram of an exemplary mind actions database 205, with respect to ability to take risk 224 of the activity module 200;

FIG. 5A is a block diagram of an exemplary actions database 206, with respect to creativity 216 of the activity module 200;

FIG. 5B is a block diagram of an exemplary actions database 206, with respect to ability to network 218 of the activity module 200;

FIG. 5C is a block diagram of an exemplary actions database 206, with respect to open-mindedness 220 of the activity module 200;

FIG. 5D is a block diagram of an exemplary actions database 206, with respect to passion 222 of the activity module 200;

FIG. 5E is a block diagram of an exemplary actions database 206, with respect to ability to take risk 224 of the activity module 200;

FIG. 6 is a flowchart an exemplary method for improving behavioral traits required for achieving success;

FIG. 7 is a flowchart illustrating an exemplary method for improving creativity 216;

FIGS. 8A and 8B are flowcharts illustrating an exemplary method for improving ability to network 218;

FIG. 9 is a flowchart illustrating an exemplary method for improving open-mindedness 220;

FIG. 10 is a flowchart illustrating an exemplary method for improving passion 222; and

FIGS. 11A and 11B are flowcharts illustrating an exemplary method for improving ability to take risk 224.

### DETAILED DESCRIPTION

I. OVERVIEW
II. UNDERLYING SCIENTIFIC PRINCIPLE
III. SYSTEM ARCHITECTURE
IV. MODULES OF SYSTEM TO IMPROVE POSITIVE TRAITS THAT ENHANCE CHANCES OF ACHIEVING SUCCESS
V. METHOD FOR IMPROVING POSITIVE TRAITS THAT ENHANCE CHANCES OF ACHIEVING SUCCESS

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a technical solution to be better at a trait or to improve a trait that is required for success. The solution is based on a principle that genetic and/or environmental factors (may be referred to as “cause”) cause particular traits to be developed as a result of human brain wirings. Human brain wirings express themselves in the form of behavioral traits (may be referred to as “symptoms”). Hence, to improve on a limiting positive trait that restricts a user from achieving success, the brain wiring(s) have to be rewired, thereby providing a wholesome and long term solution to the limiting positive behavioral traits and improving a positive trait that is required for success.

In an embodiment, a system is provided to improve the trait(s) that is/are required for success. The system may include an activity module. The activity module may be configured to enable the user to engage in one or more activities, specific to each behavioural trait, in a virtual environment. The activity in the virtual environment facilitates rewiring of a brain wiring, wherein the symptom of the brain wiring is limiting a positive behavioral trait that is required for success. The activity module may be configured to provide instructions to the user to engage in one or more mind actions, wherein the mind actions are enabled upon participating in the activities in the virtual environment to a desired extent. The activity module may be further configured to provide automated instructions to gradually expose the user to situations in a real environment. The real-world activities are enabled upon participating in the mind actions in a real-world environment to a desired extent. The situations may be generally uncomfortable to the user as a result of brain wiring. Exposure to such situation facilitates rewiring of the brain wiring required for success.

### II. Underlying Scientific Principle

Behavioral traits are in fact symptoms or consequences of the way an individual's brain is wired. The way an individual's brain is wired is based on the joint influence of genetic and environmental factors. With regards to each kind of brain wiring, genetic and environmental factors may work together in different proportions. As an example, an individual as a kid may be exposed to environmental factors such as, for an extended period of time, noticing the benefits of the long-term outcome and weighing between short term gratification and long term outcome. Said environmental factors (e.g., social interactions and cultures) along with genetic factors that may be present, cause a brain wiring responsible for having self-control.

Embodiments provide a solution to rewire the brain in order to improve and enhance on self-control, self-control being a positive trait.

It is important to identify the brain wiring that results in development of a trait that is required for achieving success. A wholesome approach to improve a positive trait in a person would be to implement ways to enhance the brain wiring that results in a trait required for success.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

As an example, behavioral traits that are required for success may include, but not limited to creativity, ability to network, openness or open-mindedness, passion, and ability to take risk, among others. A person has to be better at these traits by overcoming lack of creativity, inability to network, closed-mindedness, lack of passion and risk aversiveness. Lack of creativity, inability to network, closed-mindedness, lack of passion and risk aversiveness are symptoms or consequences of the way an individual's brain is wired and restricts an individual to achieve success.

Creativity is defined as production of novel and useful ideas in any domain. It is considered as one of the most important of all traits. Lack of creativity may be a result of overprotective and over judgmental authority figures, such as parents and teachers, punishing children for daring to try different routes, and the current education system that teaches one right answer to a question and doesn't appreciate unexpected answers. A less creative person tends to pursue a task in the same way repetitively, less inquisitive, lack curiosity in their life and accept things as it is, believe in facts which are already well established, plan to live life in a systematic way, avoid going out of their way to explore new things, make very good decisions depending on available facts, less imaginative and humorous in their life.

With regards to lack of creativity, the brain of a less creative person is wired such that the person is limited in his ability to associate diverse concepts by matching their shared properties. Additionally, the brain of a less creative person is wired such that the person is limited in his ability to associate a purpose with diverse concepts by matching his shared properties, which may be considered as a defective brain wiring.

On the other hand, creativity may be a result of parents give freedom to their children with continuous monitoring, evaluation and direction and educational system that encourages imagination, curiosity, challenge assumptions, and teach creative problem solving instead of rote memorization. Additionally, creative individual daydreams, spends some time alone to think about them and reflect on what they think in their life, applies their experiences in life to solve problems, challenges status quo and always reflect on the present rules or regulations, displays a great deal of curiosity about many things, exhibits inquisitive behaviour, criticizes constructively and values their own independence and autonomy.

With regards to creativity the brain of a creative person is wired such that the person is able to associate diverse concepts by matching their shared properties. Further, a person is able to associate a purpose with diverse concepts by matching their shared properties. These brain regions and neural network of the individual are responsible for lack of creativity or creativity. The brain regions involved in inability to network include the dorsolateral prefrontal cortex (dlPFC), Inferior parietal lobule (IPL), Posterior cingulate cortex (PCC), Dorsal anterior cingulate cortex (dACC), Basal insula (bInsula). These brain parts or networks which activates and deactivates in a synchronous process to come up with innovative or creative idea. Divergent thinking is the primary process of creativity which involves all the three networks working together in a simultaneous activation and inactivation. Whole brain imaging analysis have revealed a distributed network associated with divergent thinking. This network consisted of several core default regions, including the precuneus, PCC, and bilateral IPL, as well as the right DLPFC, a core region of the executive network. The network also included the hubs of the salience network (bilateral insula and ACC). This whole network involves creative cognition, memory retrieval. Together, results from the whole-brain analysis indicates a greater cooperation between brain regions involved in spontaneous thought, cognitive control, and semantic memory retrieval. During the creative process at first DMN gets activated (IPL, Precuneus and PCC) and is initially connected to salience network which allows dynamic coupling of knowledge/experiences/observation with the purpose and helps to generate an idea/concept. Both these networks help to come up with a random idea or concept but when it requires execution, executive network gets activated (DLPFC) and shows strong connection with DMN. Taken together, such dynamic coupling may reflect cooperation between brain networks associated with cognitive control and spontaneous thought, consistent with recent theorizing on the role of attention in creative cognition. So, to make people creative we have to strengthen the connection between DMN, and salience network.

Networking is about building and maintaining new relationships. Networking helps an individual's chances of employment, increases one's contacts and can help improve your business. Lack of networking abilities may be a result of parental restrictions, cultural background that does not encourage open networking, school environments that do not encourage group activities, participation in school events etc. A person who lacks networking abilities may talk about themselves when they meet others for the first time, not follow up on people they met in the networking event, always think about their own benefits, not offer anything to the person who they are connecting with, not clear about what they are approaching someone for, may be uncomfortable approaching new people and may be unaware how to approach new people.

With regards to lack of networking abilities, the brain of a person with poor networking is wired such that the person is biased to focus on the benefits they would receive rather than exploring others' perspectives and lives, which is an alternate brain wiring. Further, the brain of a person poor networking is wired such that they are biased to focus on the efforts involved in maintaining a relationship rather than the benefits to the other party. Such brain wirings may have been caused by genetic predisposition and stressful life experiences and lack of social support.

On the other hand, good networking abilities may be a result of parents who are good at socializing themselves which the individuals imitated or modelled, culture that encourages open networking, schools that encourage group activities, participation in school events and varied experiences in life that has forced one to be good at networking. A person with good networking abilities builds rapport with other individuals, makes an effort to maintain the relationships, builds conversation based on common grounds, shows genuine curiosity in others conversations, is a good listener as people always like to be heard and is generous in nature.

Open-mindedness or Openness is receptiveness to new ideas. Open-mindedness relates to the way in which people approach the views and knowledge of others, and incorporate the beliefs that others should be free to express their views and that the value of others' knowledge should be recognized. A closed mind filters out and blocks off new or different ideas, information, and beliefs. A person can be generally or specifically closed-minded. A few people have fixed and final opinions on pretty much everything. They may be unwilling to listen to and even-handedly consider ideas different from their own in matters of religion, morality, sex, or politics and the like.

Closed mindedness may result from exposure, where caretakers of an individual have shown disrespect to the diversity and differences present in society and the individual was only encouraged to follow one particular religion and the caretaker was not appreciative of other religions. A closed-minded person may find it difficult to categorize when the information they receive is contradictory to their perspective, reject situations/information that can be interpreted in multiple ways as this causes discomfort, work only on certainty as they have the necessity to know the probable outcome of any situation/information. Further, a closed-minded person may exhibit resistance to new ideas, judgmental behaviour, reluctance to accept disagreements, generalization of an opinion, inability to see things in different angles, focus their attentions more on the limitations of any aspect than focusing on the possibilities and selective exposure.

With regards to closed mindedness, the brain of a closed-minded person is wired such that the person is biased to avoid any information that conflicts with their pre-existing ideas/concepts, which is an alternative brain wiring.

On the other hand, open mindedness or openness may be a result of open minded parents who encouraged the individual to look at the positives of every individual and situation, demonstrated an acceptance of differences in people and encouraged the individual to consider alternate reasons for the behaviour of people. An open-minded person may be curious by nature, have respect for others, try new things, learn new things, sees things from different perspectives and focus on positives.

Passion is an eager interest or admiration for a proposal/cause/discovery/activity or love—to a feeling of unusual excitement, enthusiasm or compelling emotion, a positive affinity or love, towards a subject. Lack of passion may be a result of parents suppressing kids from doing what they are interested in and forcing them to learn what the parents are good at, school that always stresses on competition and measures success and failure only depending on the outcome rather than focusing on the positives learnt from the journey, training students to focus on the futuristic outcomes of doing something for a task, rather than focusing on the present positives. A person with lack of passion may give up easily, need an external push or motivation to complete an activity or task, may be stuck in their thoughts and are afraid to do anything as they fear it will be a wrong decision.

With regards to lack of passion, the brain of a non-passionate person is wired such that the person is biased towards focusing on the outcome rather than the positives of the journey, which may be considered as an alternative brain wiring.

On the other hand, passion may result from encouraging the individual to participate in all the activities and enjoy rather than thinking about the performance or outcome and encouraging learning over performance. A passionate person may never give up, may always be self-motivated, never get stuck in their thoughts and may be focused.

People who are passionate are always intrinsically motivated. Normally when a person is rewarded for his achievements VTA (ventral tagmental area) and NA (nucleus accumbens) gets activated which is the hub of dopaminergic neurons. When the person himself finds a satisfaction or enjoyment which is intrinsic, IC (Insular cortex) gets associated with VTA and NA and thus results in an endogenous positive feeling. This helps the person to get motivated.

Risk is the potential of gaining or losing something of value in an uncertain situation. A person who takes risk is a risk taker. Risk aversion is a potential attempt to reduce uncertainty to make a decision. People who don't like to take risk or who avoid uncertain situations is a risk aversive.

Risk aversiveness may be a result of encouraging an individual to become more organized, overschedule his/her daily routines, authority figures supervising every decision of the individual's life. Additionally, presence of DRD4 gene in an individual that creates a blockage in dopamine signaling in the brain may cause an individual to be risk aversive. A risk aversive person may follow rules and rely on what already been established, be very defensive in all aspects of life, need someone's help or opinion while taking a decision, fear loss before taking any decision, do routine work and never get bored of it, always engage themselves with those works which guarantees their win and suggest others to have a backup before taking any decision.

With regards to risk aversiveness, an individual's brain is wired such that the individual is inclined to amplify the disadvantages and de-amplify the benefits of an action in an uncertain situation. Further, the individual's brain is wired such that the individual is inclined to amplify the disadvantages and de-amplify the benefits of an action in an uncertain situation, which is an alternative brain wiring.

On the other hand, ability to take risk may be a result of encouragement to individuals to create their own schedule of what they want and how they want in their life, giving individuals enough time to have outdoor activity and experience completely new situations, giving enough support to make decision independently in life when an uncertain situation comes in life which leads to risk taking. A risk taker challenges status quo in their life, is not afraid of uncertain situation, likes to be independent in case of taking decision and have trust on their decision, likes to break the rules and routine in their life, feels happy to engage themselves in situation which is uncertain and likes to explore new places while travelling, food or things which gives thrilling experiences.

Different brain regions involved in risk seeking and risk aversion: VMPFC, VLPFC, OFC, ACC, Striatum, and Amygdala. Risk seeking and risk aversion is a sequential process. Emotional value or psychological value of stimuli has a huge role to play in case of risk seeking and risk aversion. Neural representation of stimuli value has been done in OFC, and amygdala. Amygdala has close and bidirectional connections with OFC and both are involved in stimuli reinforcement learning. The whole process of risk seeking or risk aversion can be divided into four step i.e. Representation of stimuli, Value addition to stimuli, Action selection and Outcome evaluation. An early study of children and adolescents responding to monetary gains and losses found increased activation in ventral striatum (VS) and lateral and medial orbitofrontal cortex (OFC) for gains relative to losses. Reward studies have showed that the potential gain has a huge role to play in risk seeking. Neural representation of potential gain and potential loss leads to activation of OFC, amygdala, ACC, VMPFC, and striatum but activation increased parametrically with increasing potential gain and decreased parametrically with increasing potential loss. This study shows that the risk aversive people are more sensitive or biased towards the potential loss. In another study, it has been established that risk seeking or taking is associated with reduced MPFC activation which supports the theory that kids take more risk than adults because their PFC has not yet developed. These findings suggest that developmental changes in both brain and behavior may lead to shifts in what information is most important to individuals when assessing risk. Because the MPFC has been implicated in the representation of value during risky decision-making, this finding may suggest that adolescents who are more inclined toward real-world risk-taking rely less on value assessments (rational thinking) when evaluating choices than less risk-prone adolescents do. Risk takers just rely on hot cues or reward of the risk and make the decision.

### III. System Architecture

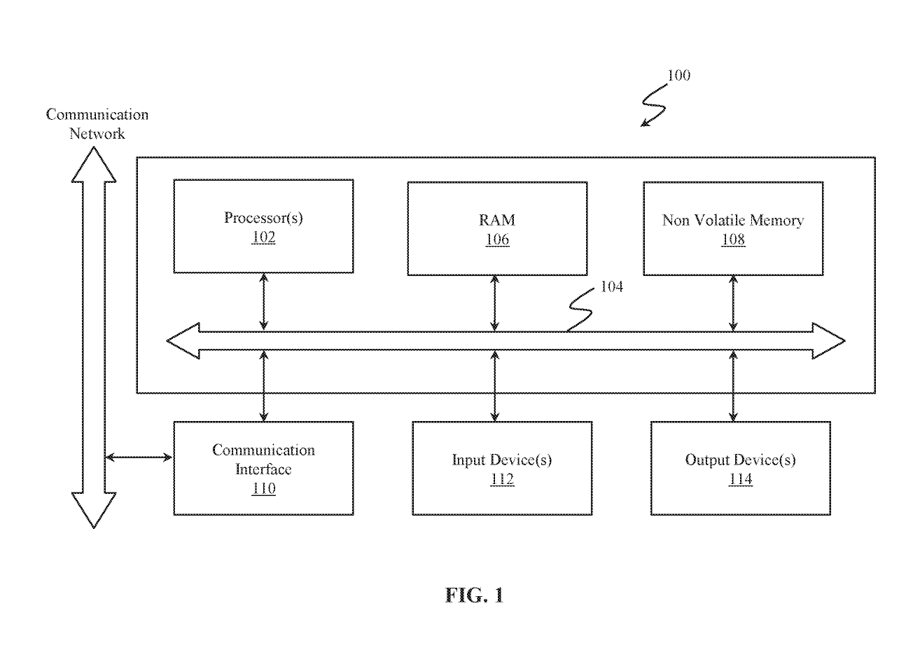

Referring to the figures, more particularly to FIG. 1, an exemplary architecture of an exemplary system 100 to improve positive behavioral traits that are required for achieving success, is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more computer processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

IV. Modules of System to Improve Positive Traits that Enhance Chances of Achieving Success

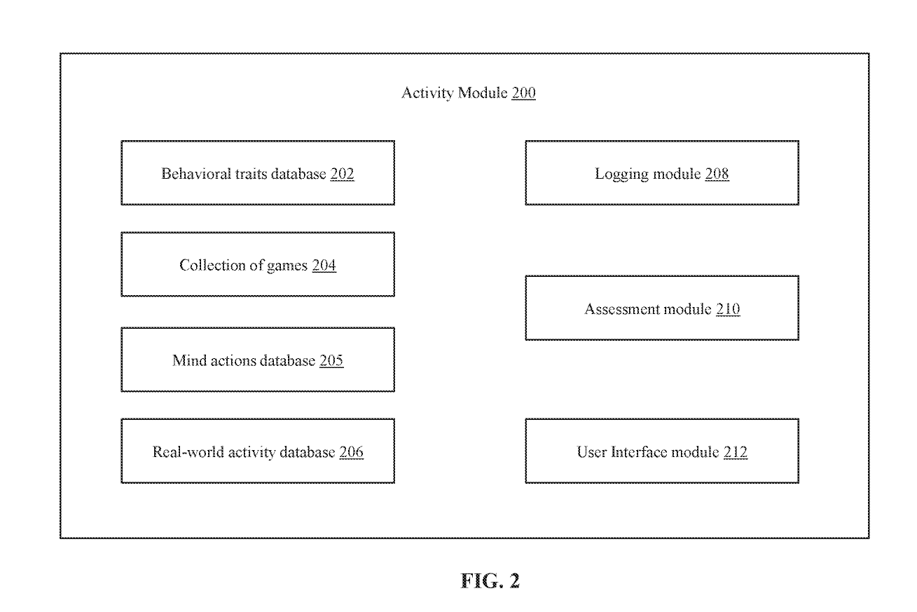

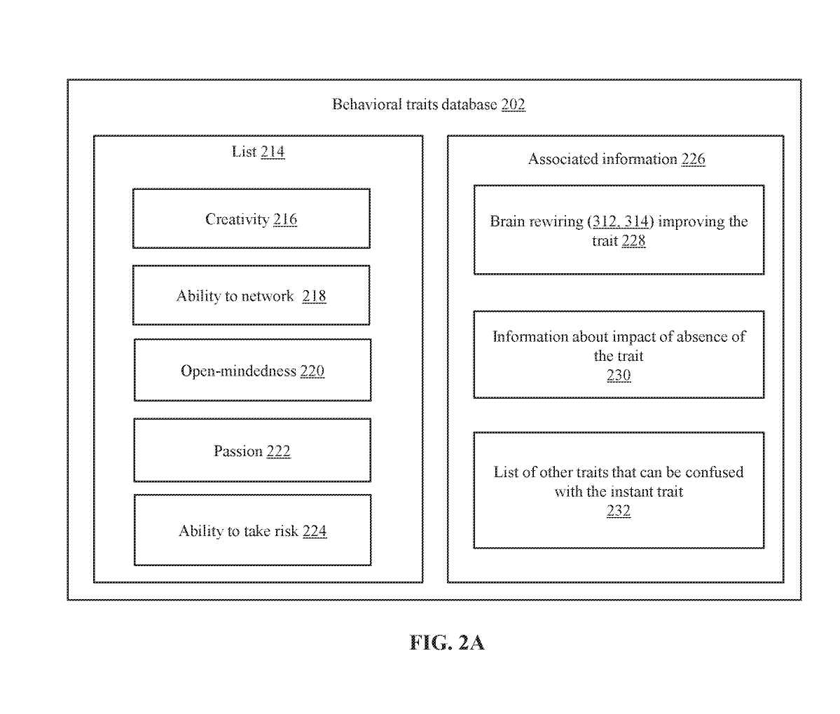

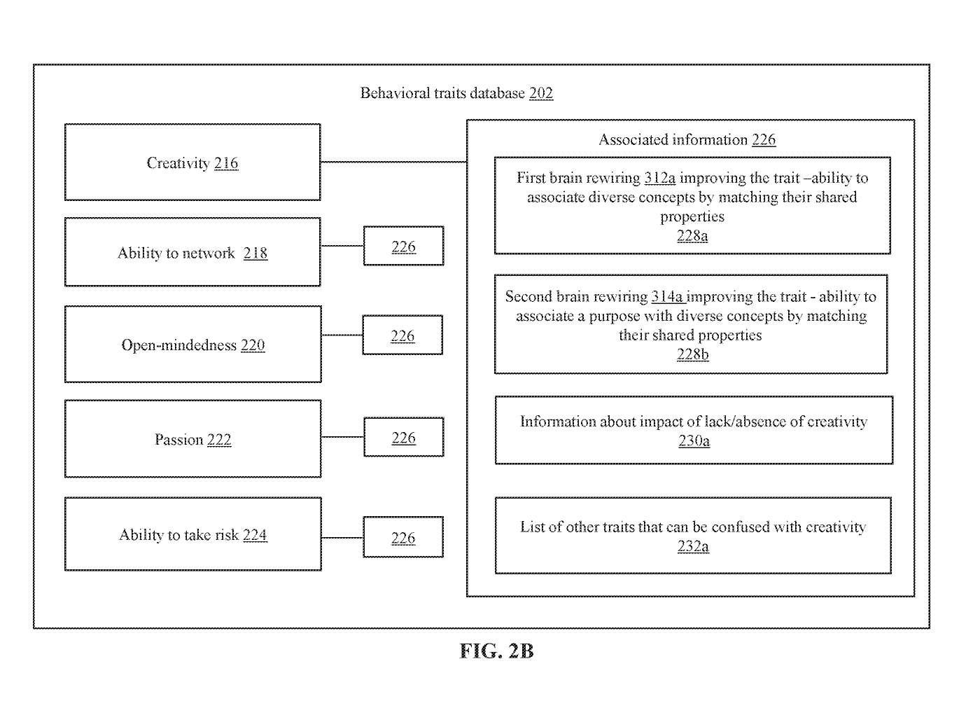

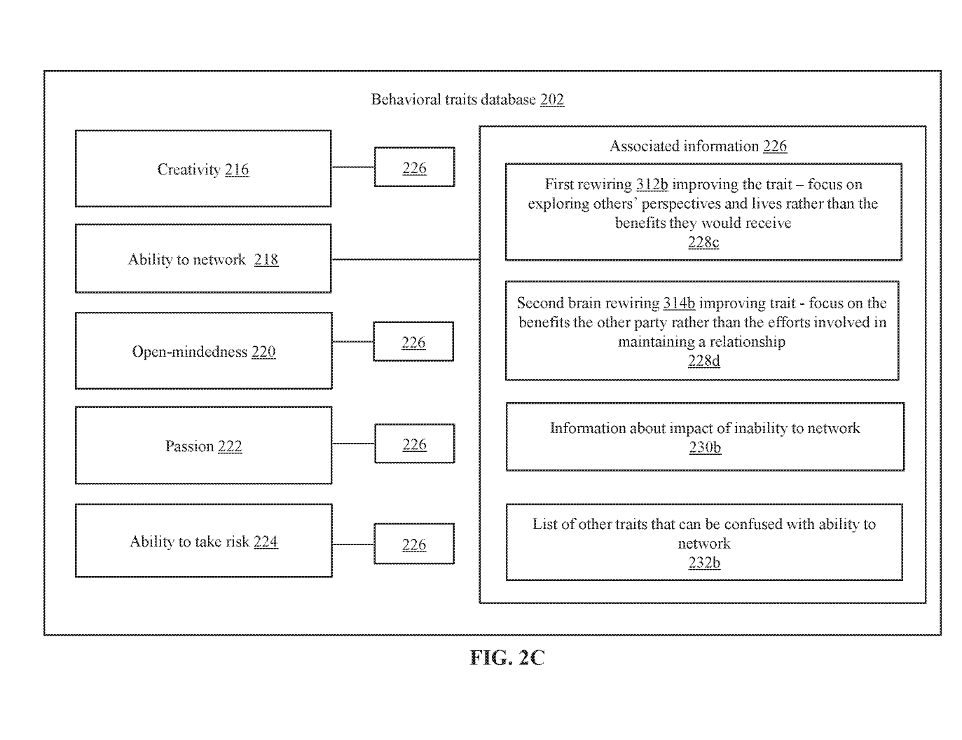

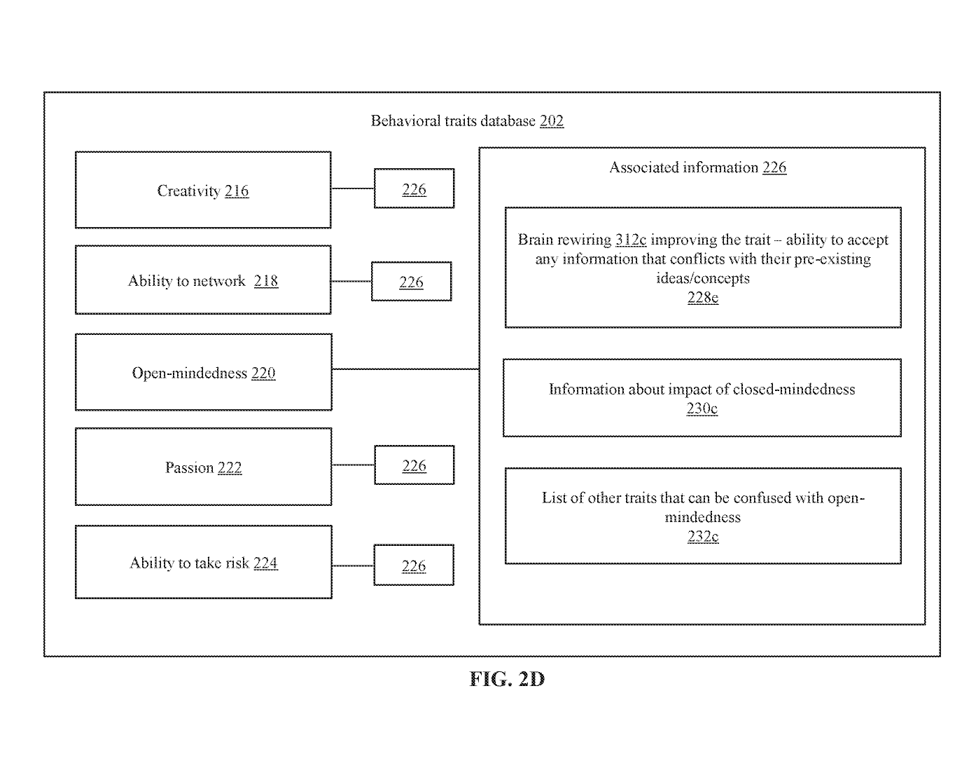

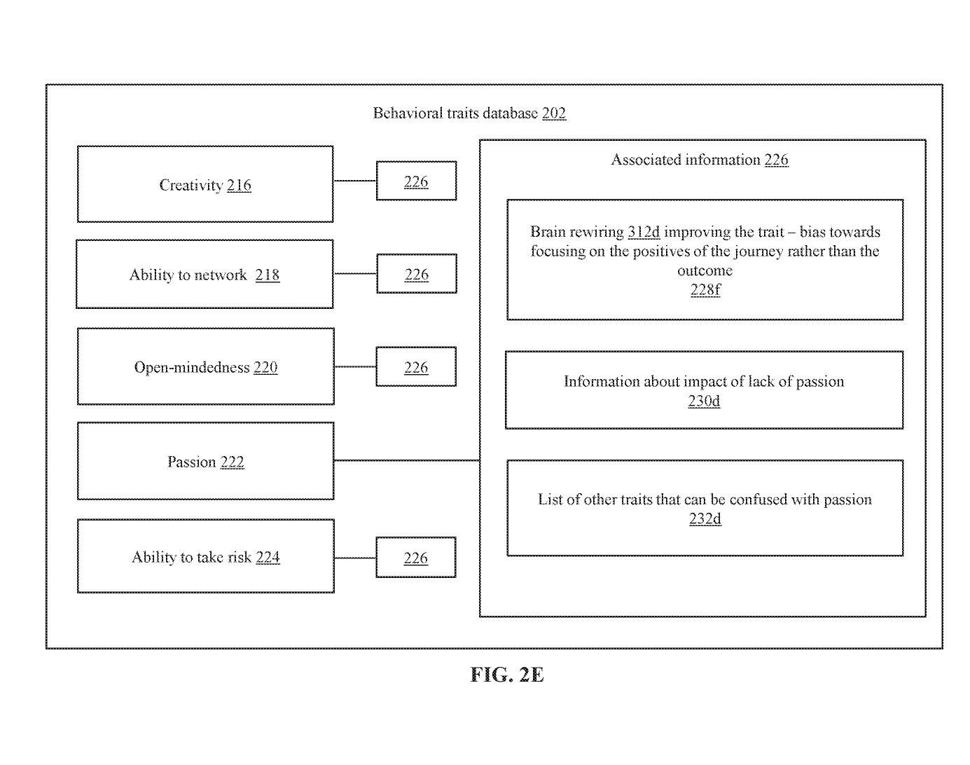

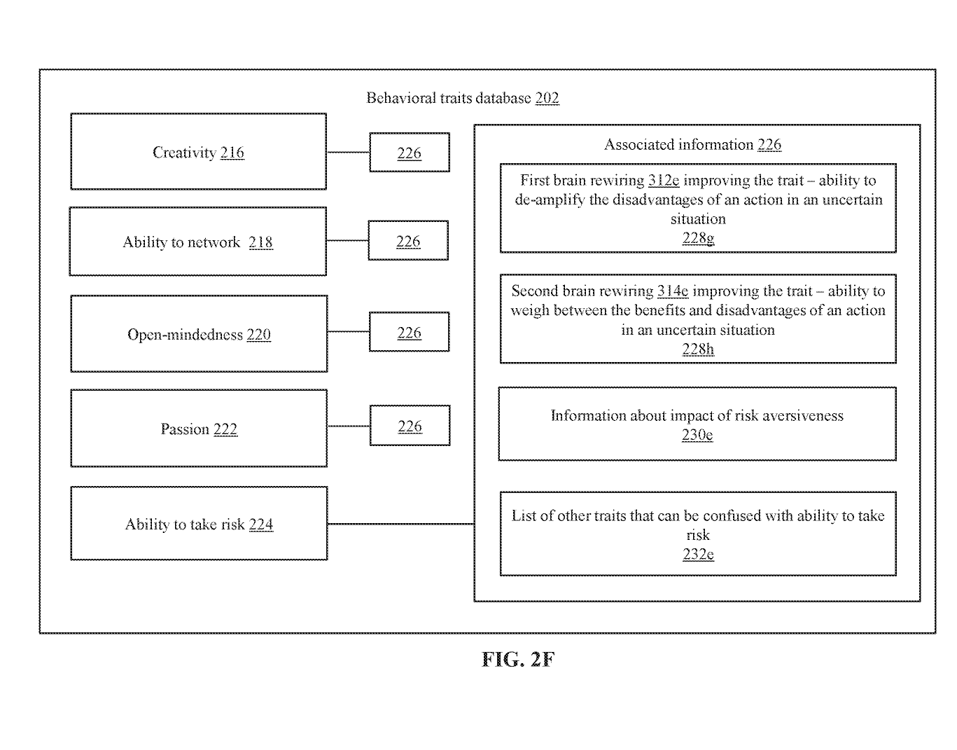

Referring to the figures, and more particularly to FIG. 2, the system 100 includes various modules that enable users to be better at or to improve on traits that are required for success. The system 100 includes an activity module 200. The activity module 200 may be a gaming module (200) or an application module (200). The activity module 200 may be hosted by a communication device that enables a user to play games. Examples of such communication devices may include smart phone, tablet, notebook, laptop and desktop computer, among other devices.

The activity module 200 may include a behavioral traits database 202 specific to success, a collection of games 204, a mind actions database 205, an actions database 206, a logging module 208, an assessment module 210 and a user interface module 212.

### Behavioral Traits Database 202

Referring to FIG. 2A, in an embodiment, the behavioral traits database 202 may include a list of behavioral traits 214. The behavioral traits 214 may be as an example, specific to success. Behavioral traits database 202 includes the behavioral traits 214 that are required for an individual for achieving success. Database 202 includes behavioral traits 214 not limited to, creativity 216, ability to network 218, open-mindedness/openness 220, passion 222 and ability to take risk 224, among others.

The traits database 202 may further include, with respect to one or more of the behavioral traits 214, information 226 associated with the trait 214. Associated information 226 may include information corresponding to the brain wiring 228 resulting in the trait 214, information about impact 230 in absence of the trait 214 on a person, and a list 232 comprising one or more traits 214 that may be confused with the instant trait, among other information. Some or all of the associated information 226 may be displayed to the user of the activity module 200.

Referring to FIG. 2B, a first brain wiring 228a resulting in creativity 216 is the brain wiring resulting in ability to associate diverse concepts by matching their shared properties. A second brain wiring 228b resulting in creativity 216 is the brain wiring resulting in ability to associate a purpose with diverse concepts by matching their shared properties.

In an embodiment, the information corresponding to the first and second brain wiring 228a, 228b resulting in creativity 216 enables the activity module 200 to select games, activities or actions to improve creativity 216.

In an embodiment, displaying the information corresponding to the brain wiring 228a, 228b resulting in creativity 216 motivates the user to follow the instructions provided by the activity module 200 in order to improve creativity 216.

Information 230a about impact of absence or lack of creativity can include one or more of tendency to pursue a task in the same way repetitively, lack of inquisitiveness, lack of curiosity in their life and accept things as it is, believing in facts which are already well established, planning to live life in a systematic way, avoiding going out of their way to explore new things, making very good decisions depending on available facts, lack of imagination and humor in their lives, among others.

List 232a of other traits that can be confused with creativity 216 may include curiosity, sensitivity and risk taking, among others

With regards to creativity 216, the brain rewiring attempted to improve creativity 216 includes rewiring the brain wirings 228a, 228b such that ability to associate diverse concepts by matching their shared properties is increased and ability to associate a purpose with diverse concepts by matching their shared properties is increased.

In an embodiment, the activity module 200 may display the information corresponding to the causes (genetic or environmental) that resulted in lack of creativity, thereby enabling the user to relate to the cause, which results in a wholesome experience while working to improve creativity 216.

Referring to FIG. 2C, a first brain wiring 228c to develop ability to network 218 is the brain wiring resulting in an individual to focus on exploring others' perspectives and lives rather than the benefits they would receive. A second brain wiring 228d resulting in ability to network 218 is the brain wiring resulting in an individual focusing on the benefits the other party rather than the efforts involved in maintaining a relationship.

Information about impact 230b of absence of ability to network or inability to network can include one or more of behaviors such as talking about themselves when they meet others for the first time, not following up on people they met in the networking event, always thinking about their own benefits, not offer anything to the person who they are connecting with, not being clear about what they are approaching someone, being uncomfortable approaching new people, and being unaware of how to approach new people among others.

List 232b of other traits that may be confused with lack of ability to network 218 include sociability, among others.

With regards to ability to network 218, the brain rewiring attempted to improve ability to network 218 includes rewiring the brain wirings 228c such that the ability to explore the perspectives and lives of other individuals rather than thinking of their own benefits is increased. Further, the brain rewiring attempted to improve ability to network 218 includes rewiring the brain wirings 228d such that the ability to focus on the benefits of the relationships to the other party rather than the efforts of maintaining a relationship is increased.

In an embodiment, the activity module 200 may display the information corresponding to the causes (genetic or environmental) that resulted in the brain wirings 228c, 228d, which in turn resulted in ability to network 218, thereby enabling the user to relate to the cause, which results in a wholesome experience while working to improve ability to network 218.

Referring to FIG. 2D, a first brain wiring 228e to develop open-mindedness or openness 220 is the brain wiring resulting in an individual accepting any information that conflicts with their pre-existing ideas/concepts.

Information about impact 230c of absence of openness or closed-mindedness can include one or more of need for categorization, multiple interpretation, need for certainty, resistance to new ideas, judgmental behaviour, reluctance to accept disagreements, generalization, inability to see things in different angles, focusing on limitations, and selective exposure, among others.

List 232c of other traits that can be confused with lack of open-mindedness 220 among others include creativity and sociability, among others.

With regards to open-mindedness 220, the brain rewiring attempted to improve open-mindedness 220 includes rewiring the brain wirings 228e such that the individual's ability to accept any information that conflicts with their pre-existing ideas/concepts is increased.

Referring to FIG. 2E, a brain wiring 228f to develop passion 222 is the brain wiring resulting in bias towards focusing on the positives of the journey rather than the outcome. The brain rewiring attempted to improve open-mindedness 220 includes rewiring the brain wirings 228f such that the individual's ability to focus on the positives of the journey rather than the outcome is increased.

Information about impact 230d of absence of passion or lack of passion can include one or more of giving up easily, needing an external push or motivation to complete an activity or task, being stuck in their thoughts and are afraid to do anything as they fear it will be a wrong decision, among others.

List 232d of other traits that can be confused with lack of passion 222 include sociability, among others.

Referring to FIG. 2F, a first brain wiring 228g to develop ability to take risk 224 is the brain wiring resulting in ability to de-amplify the disadvantages of an action in an uncertain situation. A second brain wiring 228h resulting in ability to take risk 224 is the brain wiring resulting in ability to weigh between the benefits and disadvantages of an action in an uncertain situation. The brain rewiring attempted to improve ability to take risks 224 includes rewiring the brain wirings 228g and 228h such that the individual's ability to de-amplify the disadvantages of an action in an uncertain situation is increased and ability to weigh between the benefits and disadvantages of an action in an uncertain situation is increased.

Information about impact 230e of absence of ability to take risks or risk aversiveness can include one or more of following rules and relying on what already been established, defensiveness, needing someone's help or opinion while taking a decision, fear of loss before taking any decision, engaging in routine work and never get bored of it, engage with those works which guarantees their win, and suggest others to have a backup before taking any decision, among others.

List 232e of other traits that can be confused with lack of ability to take risk 224 include openness, among others.

### Collection of Games 204

The activity module 200 includes collection of digital games, which are played in a virtual world. Each of the games is used by the activity module 200 based on the brain rewiring, which the game is capable of achieving.

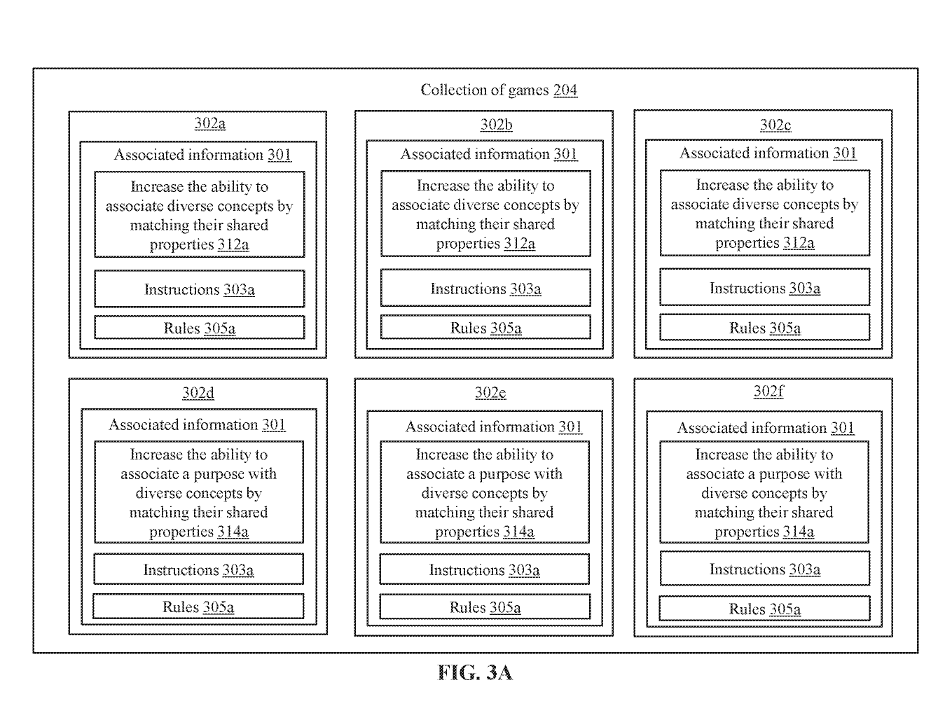

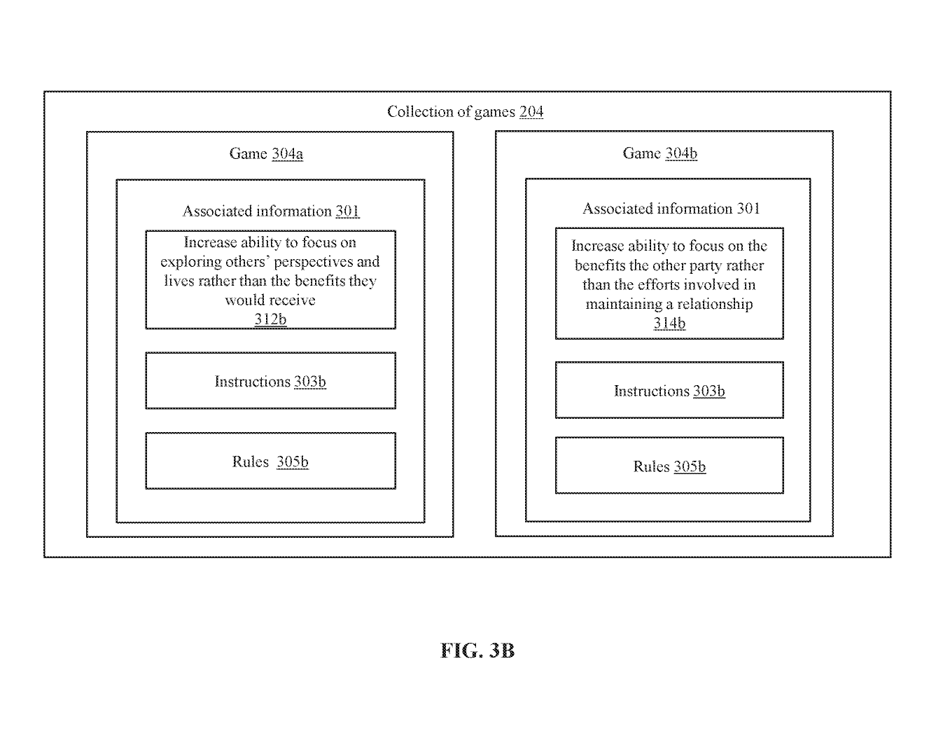

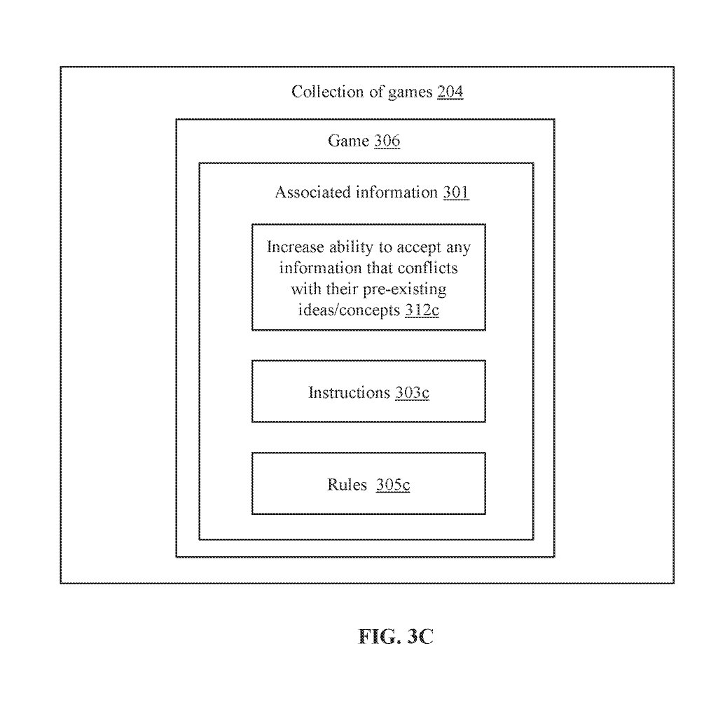

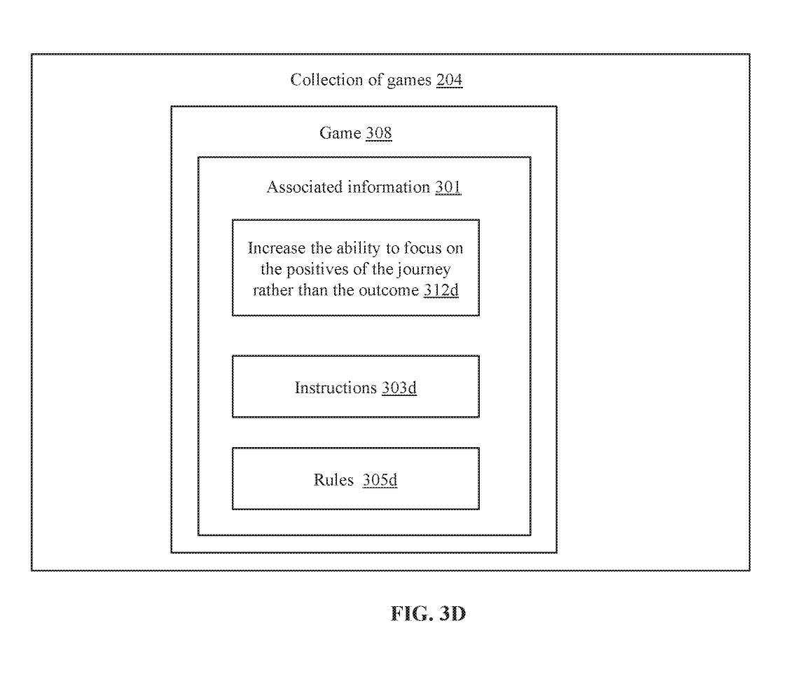

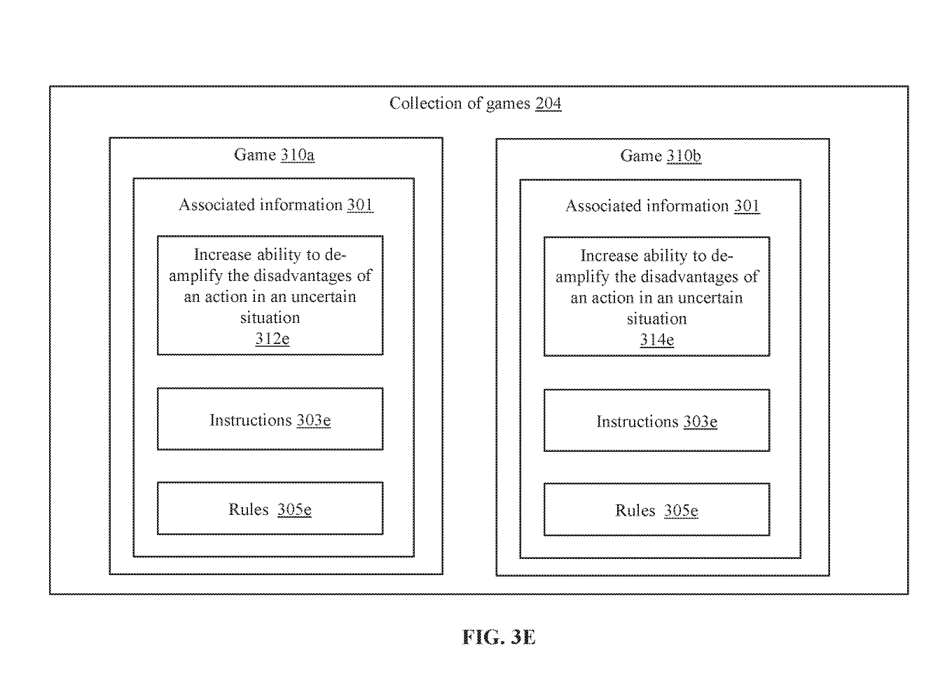

Referring to FIGS. 3A-3E, in an embodiment, each game (302-310) may include associated information 301. As an example, a game may be capable of achieving more than one type of brain rewiring. Each game includes data indicating the brain rewiring(s) 312 and/or 314, it is capable of achieving, so that the activity module 200 can opt to present a choice of one or more games, which has the capability to achieve the brain rewiring, which the activity module 200 is attempting to achieve.

The associated information 301 may include instructions 303 to be followed by the user to play the games 302-310. Associated information 226 may additionally include one or more rules 305. Examples of rules 305 include rules for playing each game, rules to proceed to a higher level, scoring method in each level and time assigned to each level to reach the end of the level, among others.

In an embodiment, a higher level of the digital game is unlocked based on predefined criteria.

In an embodiment, the higher level is unlocked upon repeatedly playing a previous level in the digital game for a predefined number of times or duration of time.

In the example presented in FIG. 3A, with regards to creativity 216, six different games 302a-302f are included in the collection of games 204. The six games may be used by the activity module 200 to improve/enhance brain wirings 228a, 228b by rewiring the brain to increase the ability to associate diverse concepts by matching their shared properties 312a and increase the ability to associate a purpose with diverse concepts by matching their shared properties 314a.

Games 302a, 302b and 302c are directed at rewiring the brain to increase the ability to associate diverse concepts by matching their shared properties 312a. Games 302d, 302e and 302f are directed at rewiring the brain to increase the ability to associate a purpose with diverse concepts by matching their shared properties 314a.

Game 302a may be a selection game where the user has to select the shared properties between two words. The words can belong to any category (Field, Object, Organization, behaviors). There will be 4 choices available to find out the shared properties. Three words belong to individual property and one shared property between the two words. Instruction 303a may include recommendation to play the game 302a for at least a predefined duration for a predefined number of days. Rules 305a may allow proceeding to a next level in the game 302a once a desired level of performance is achieved. The activity module 200 may provide instruction 303a to choose a word from the list which shares a common property between the two given words.

### 1. Example: A Disneyland B. Mobile Phones

List of words to select from:
Internet
Kids
Entertainment
Talk

Game 302b may be designed to designed to increase the level of connection in the brain by finding the shared properties. Two different words (Organizations) will be shown to the user and the user has to come up with shared properties between the two given words. The game has 2 levels. Instruction 303a may include recommendation to find the shared properties between the two words and write it down in a box provided by the activity module 200. Rules 305a may allow proceeding to a next level in the game 302b once a desired level of performance is achieved.

In a first level, the user may be provided with two words related to organization and the instructions 303a may require the user to come up with shared properties. Players have to come up with as many shared properties as they can (at least 40 words).

### Example 1: Banking and Cold Storage

Shared properties: Storage (Stores money and stores commodities), safe, increase in capital and increase in life span, trustworthy.

In a second level, the users may be given two concepts and the instructions 303a may require users to come up with shared properties for those words but this time the words will be very diverse or distantly related and players need to come up with as many shared properties as they can. Random words can be generated by mixing the combination of level 1 words (at least 40 words).

### Example: School and Banking, Club and Cold Storage

Game 302c may be designed to allow an individual to step up and find shared properties between words related to Organizations, fields, objects and behaviors. This game may have two levels. Individuals may be instructed to find the shared properties between the two words and write it down on a box provided by the activity module 200.

In a first level, the user may be given two words related to objects/organizations/fields and behaviors randomly. The user may be instructed to find as many shared properties as they can between those two words to advance. (At least 40 words).

### Example

Words:

1. Servers and School

2. Club and Self-control

3. Bank and Politics

Game 302d is directed at rewiring the brain to increase the ability to associate a purpose with diverse concepts by matching their shared properties 314a. Game 302d is designed to associate the properties of a purpose and diverse concepts by matching their shared properties. The user may be instructed to solve a problem which is called as purpose. The user may also get to see two diverse concepts sequentially. Both the diverse concepts come with 4 options to select where two options are shared properties (Between purpose and the diverse word) and two options are individual property of the diverse concept. The user need to select the either both the options or at least one. Once they are done with this action there will be a sentence shown to them which is the real solution of the purpose. The user needs to come up with 40 purposes and 80 combinations of diverse fields for the users.

### Example

Purpose: You want tourist to enjoy local essence of place such as food. How will you do it?
Select the shared properties between diverse concepts and the purpose
Restaurant—Homemade food, Native people, Managers, Variety of food.
Technology—Programming, Developers, E-commerce, order quickly.
Correct answer is Native people, variety of food, Order quickly and E-commerce
Solution shown to them: Homemade food prepared by native people can be ordered online and delivered by a restaurant.

Game 302e is directed at rewiring the brain to increase the ability to associate a purpose with diverse concepts by matching their shared properties 314a. In this game the users will be asked to pick a field in which they want to be creative such as Artistic/Literature, Business and Society. Once they choose a field, a purpose will be given to them with two diverse words related to any of the four concepts (objects, organizations, fields and behaviour).

Under artistic/literature, there may be two sections; a) short story b) poem. It will be shown sequentially to the user. Under business, the user may be instructed to provide all the new business ideas and under society social problems may need to be addressed.

### Example

### Artistic

### Section: Short Story

In this game the user needs to find out the shared properties between the concepts or words what we are giving and then they have to write a story by using those shared properties. It has two levels. But in the second level there will be three words.

In a first level, there will be only two words and the user may be instructed to write a short story by finding shared properties between the two words, type the shared properties in a box provided by the activity module 200 and write a short story by including all the shared properties that the user may have come up with. Examples of words may be school and science.

In a second level, the user may be instructed to write a short story by finding shared properties between three words, type the shared properties between all three in the box and write a short story by finding shared properties between the three. Examples of words may be self-control, bank and computers. The user may need to write a short story by including all the shared properties that he has come up with.

The user has to write a small poem of at least 8 sentences by finding the shared properties between the words provided by the activity module 200. Game will work in the same way as short story writing.

In a first level, there will be only two words and the user may be instructed to write a poem including at least 8 sentences using the two words. The user may be instructed to type the shared properties in a box provided by the activity module 200. Examples of words may be growth and psychology.

In a second level, there will be three words and the user may be instructed to write a poem including at least 8 sentences using the three words. The user may be instructed to type the shared properties in a box provided by the activity module 200. Examples of words may be banking, war and industries.

In game 302e, under business, the user may be given a purpose in the field of business and there will be words (organization, objects, behaviour and fields) to find the shared properties. User needs to find the shared properties between given words and the purpose to come with an innovative idea. There are two levels and the only difference is in the number of words they have to use to solve the problem.

### Level 1

Purpose: Many students and professionals eat alone in their campus. You need to come up with an idea which can solve the problem of eating alone in their campus.
Combination 1: Technology
Come up with the shared properties between Technology and the purpose.
Combination 2: Time
Come up with the shared properties between Time and the purpose.
Write down the idea which can serve the purpose

### Level 2

Purpose: We like to explore and enjoy during vacation but carrying baggage and booking hotel tickets is a hectic task. You need to find out a solution which can work as a business model too.
Combination 1: Online bookings
Come up with the shared properties between online bookings and the purpose
Combination 2: Baggage claim area
Come up with the shared properties between baggage claim area and the purpose
Combination 3: Management
Come up with the shared properties between management and the purpose
Now come up with an idea which will serve the purpose by using the shared properties that you have come up with.

In game 302c, under society, the user may be instructed to solve few social issues and it will follow the same game structure as business category. This game has two levels.

### Level 1

Purpose: Come up with an idea to tackle isolation and loneliness of older people in the society.
Combination 1: Children
Come up with the shared properties between children and the purpose
Combination 2: Drama
Come up with the shared properties between drama and the purpose
Now come up with an idea which will serve the purpose by using the shared properties that you have come up with.

### Level 2

Only one more combination will be added as combination 3 and rest is same as level 1
Write down all the properties of children, drama, and charity. Write down all the shared properties between them and come up with an idea which can solve the problem Try to find out shared properties between children, drama, and charity.

In the example presented in FIG. 3B, with regards to ability to network 218, games 304a and 304b may be designed to enhance brain wirings 228c, 228d by rewiring the brain to increase ability to explore the perspectives and lives of other individuals rather than thinking of their own benefits 312b and to increase ability to focus on the benefits of the relationships to the other party rather than the efforts of maintaining a relationship 314b. Game 304a may be directed at increasing ability to explore the perspectives and lives of other individuals rather than thinking of their own benefits 312b. Game 304b may be directed at increasing ability to focus on the benefits of the relationships to the other party rather than the efforts of maintaining a relationship 314b. All the games are played in a virtual environment.

Game 304a may be a selection game directed at modifying the bias. A situation will be shown and one statement from each of the two categories shown will be chosen randomly and displayed. Instruction 303b may require the user to select one statement from the two given preferences. Rules 305b may allow proceeding to a next level in the game 304a once a desired level of performance is achieved. Game 304a may present an example of a possible real life situation/event.

### Example

Situation: You are traveling in the train to your hometown, and you have a Japanese stranger who is old as your travel partner.
Benefits of Exploring the perspectives:
   You will be able to understand the person's view on various things when you talk to the stranger.
   You would get to know different kind of cultures.
   You might end up getting new perspectives ideas as you talk new people.
   You would be able to increase your knowledge about various philosophies.
   You can increase your knowledge by talking to them and they might be an expert in few areas.
   You would like to know how Japanese find spouses.
Thinking of your own benefits
   You can get the stranger as your potential client for your product.
   The stranger is a founder of a company, so you can get a deal done with him.
   By talking to the stranger, you can get more connections for the sales.
   By networking with the stranger, you can get ideas to start up something new in collaboration.
   If the conversation goes well, the stranger might be my potential employer.

Game 304b may be a selection game directed at modifying the bias. A situation will be shown and one statement from each of the two categories shown will be chosen randomly and displayed. Instruction 303b may require the user to select one statement from the two given preferences. Rules 305b may allow proceeding to a next level in the game 304a once a desired level of performance is achieved. Game 304a may present an example of a possible real life situation/event.

### Example

Situation: You met an old schoolmate in a conference that you attended.
Benefits of the relationships to the other party:
   Your schoolmate is getting married to someone from your community, so you can help him by teaching few rituals of the community.
   As your schoolmate in entering a new phase of life, you can lend a supporting hand by being there for him.
   You will be able to help your schoolmate find a place to stay as he is from another city.
   You can increase your knowledge by talking to each other on various topic each of you have expertise in.
   You will be able to spend time with each other in the time of special occasions.
Efforts in maintaining the relationship:
   You need to mail/call/text the person in a regular interval of time, so it is a task to do that.
   You need to take time out to constantly follow up, which will be tiring, so it is better to let go.
   You need help the person when he/she seems to require help, which can be effortful.
   You have many other important tasks to take care of, so this will just add on.
   You are not even sure if you two would benefit from each other, so why waste energy to keep in touch.

Referring to FIG. 3C, with regards to open-mindedness 220, game 306 may be directed at rewiring 312c the brain to increase ability to accept any information that conflicts with their pre-existing ideas/concepts. The game 306, can be used by the activity module 200 to enhance brain wiring 228e. Game 306 is played in a virtual environment.

Game 306 may be a selection game and instruction 303c may require a user to select one or more options from a list provided by the activity module 200. Rules 305c may allow proceeding to a next level in the game 306 once a desired level of performance is achieved.

### Example

Select an option that you believe in?
Zodiac Signs
Being Rational
Not sure
   Belief in zodiac signs

### Pros

You can eliminate problems that may arise in the future by taking the predictions into account.
You can be mindful of the good times and make extra efforts for good results.
Knowing things helps you constantly judge and analyse your actions in accordance to your situation.
You find yourself prepared in times of adversity so as to minimize the losses.
You can also take corrective measures as suggested. These measures involve wearing stones, chanting mantras, and they are potent enough to help you.
You will be able to answer a few unanswered questions as the events are very confusing.
Many people believe in zodiac signs as it helps them make sense of their life.
You feel like there's an amount of certainty to your life.
Zodiac signs give an insight into others' characteristics and help them in adapting with their weaknesses and strengths.
Through these predictions, you are able to see what signs you are most compatible with and accordingly you can find your life partner.

### Cons

There is inconsistency with predictions as they vary depending on who's making them.
Zodiac signs do not explain the overall aspects of life.
Many people fall into depression after they foresee some problems in the future and stop trying. This is because they constantly think that their actions won't yield any results.
Many people start believing in luck and destiny instead of hard work and efforts. This can be counter-effective as zodiac signs never propagate it. In fact, unless you work you will never get favourable or unfavourable results.
Sometimes zodiac signs make wrong predictions.
Zodiac signs lead people into thinking that a bunch of imaginary signs could influence the course of their future. This means that whatever we do is a result of how stars and planets move in space.
Sometimes knowing the zodiac sign of an individual, people tend to judge you based on the general characteristics of that zodiac signs.
Sometimes zodiac signs say the same things to everyone. As there are certain areas for which people tend to visit astrologers for help.
The predicted information may have a completely opposite consequence on the person and may backfire.
Sometimes zodiac signs have negative predictions and the individual may believe it to be true and associate it with their personality. This may result in them having low self-esteem.

### Rationalism

### Pros

Rationalists do not depend on external factors for their success.
Individuals who are rationalists believe in weighing their options realistically.
Rational individuals attribute their success to their own hard work.
Rationalists depend on empirical evidence than abstract views.
Rationalists are less likely to feel like victims of circumstances as they are self-sufficient.
Rational individuals are more likely to observe factors that they can use to create positive outcomes in their future
Rationalists usually believe that outcomes are in their control.
Rationalists engage in activities that will improve their situation.
Individuals who are rationalists are constantly striving to achieve more.
Rationalists are inquisitive, and try to figure out why things turned out the way they did.

### Cons

Sometimes rationalists realize that hard work is not sufficient to be successful, hence rationalism fails.
Sometimes they are unable to explain events when it is not in a person's control.
Rationalists come across as arrogant to other people.
Rationalists exhibit annoyance at events that don't match their expectations.
Individuals who are rationalists are rigid in their viewpoint.
Rationalists are at a disadvantage as they cannot deal with ambiguous situations.
Rational individuals tend to over-think and that causes them some discomfort.
Being rational sometimes keeps other people away as they cannot relate.
Individuals who are rational tend to have higher expectations which will affect them mentally as they end up being unhappy.
Rationalists tend to disregard emotional aspects of any situation which is an important part of any human interaction.

In an example presented in FIG. 3D, with regards to passion 222, game 308 can be used by the activity module 200 to enhance brain wiring 228f by rewiring the brain to increase the ability to focus on the positives of the journey rather than the outcome 312d.

Game 308 is a selection game directed at modifying the bias. In game 308, a situation will be shown and one statement from each of the two categories shown below will be chosen randomly and displayed. Instruction 303d may require the user to select one statement from the two, giving preference for the statement that helps them give priority to focus on the positives of the journey than the outcome. Rules 305d may allow proceeding to a next level in the game 308 once a desired level of performance is achieved.

### Example

Situation: You have gone trekking in a forest.
Focusing on the positives of the journey:
   Cooking for and serving delicious meals to others is an extremely satisfying experience.
   I am getting the opportunity to taste different cuisine.
   It is so wonderful to witness so many people from different backgrounds coming together in their love for trekking.
   I never thought that I have the ability to create fire by the primitive way.
   It's a whole new experience to see clouds floating right in front of me.
Focussing on positives of the outcome:
   Trekking will help me improve my management skills.
   I will probably find a partner in this trek.
   I will be the first one to complete this trek in my group.
   I will be more disciplined after the trek.
   My peers will be proud of my achievement.

Referring to FIG. 3E, with regards to ability to take risks 224, games 310a-310b are included in the collection of games 204. Games 310a-310b can be used by the activity module 200 to improve brain wirings 228g and 228h by rewiring the brain to increase ability to de-amplify the disadvantages of an action in an uncertain situation 312e and to increase ability to weigh between the benefits and disadvantages of an action in an uncertain situation 314e.

In an embodiment, games 310a may be played to increase ability to de-amplify the disadvantages of an action in an uncertain situation 312e and game 310b may be played to increase ability to weigh between the benefits and disadvantages of an action in an uncertain situation 314e.

Game 310a may be a selection game designed to enable users to de-amplify the disadvantages of an action in an uncertain situation 312e. Instruction 303e may require a user to select an option from a list of options provided by the activity module 200. Rules 305e may allow proceeding to a next level in the game 310a once a desired level of performance is achieved.

### Example

Fact: You like one of your colleague and you want to ask for a date
Select the fact which is shows de-amplification of disadvantages
Negatives (Mixture of amplified disadvantages and de-amplified benefits)
   1. She/he will never talk to me again
   2. She/he will unfriend me from social networking
   3. My image will get ruined in front of her/him
   4. I will get a chance to know her better but it is not going to make a difference in life
   5. I will get to enjoy a day off but it might hamper my work.
Positives (Only de-amplified disadvantages)
   1. Even if she/he won't accept, it doesn't make a difference in my life
   2. She/he might be shocked but this may work in my favor
   3. Any way I am going for a vacation next week so things will get settled by then
   4. It's not going to bother her as she/he is very open minded
   5. He/she can leave anytime soon so it will be fine if it doesn't work out

Game 310b may be a facts game designed to rewire the brain to enable users to weigh between the benefits and disadvantages of an action in an uncertain situation 314e. Instruction 303e may require a user to select an option from a list of options provided by the activity module 200. Rules 305e may allow proceeding to a next level in the game 310b once a desired level of performance is achieved.

### Example

Fact: You are supposed to book a last-minute flight ticket for an uncertain vacation trip.
Disadvantages:
1. You don't know much about the place and you may face problems
2. It might cost you more for the flight bookings
3. The place might be very costly
4. You have to travel alone for few hours
5. You have to inform your family members immediately as they were having some plans
Advantages:
1. You will be to meet your friend after a long time
2. You may experience something new which you haven't
3. You will learn to book tickets and take decision when you have no time to waste
4. You will learn to do packing during paucity of time
5. You will come to know who can help you in this kind of situation
Will you book tickets for this uncertain plan?
YES

### Mind Actions Database 205

The mind actions database 205 includes information corresponding to a plurality of mind actions or mind games or sets of mind actions or games. Mind actions or games may be performed by thoughts as opposed to the digital games. Examples of mind actions may include, but not limited to meditation, connecting to one's past, seeing thing from other's perspectives and reconsidering one's thoughts, among others. Mind actions may be performed after one or more levels of each digital game is reached. Each mind action included in the database 205 may correspond to a brain wiring (228a-228h). Each mind action may be performed to enhance or improve the brain wirings (228a-228h) to develop traits 214 required for success.

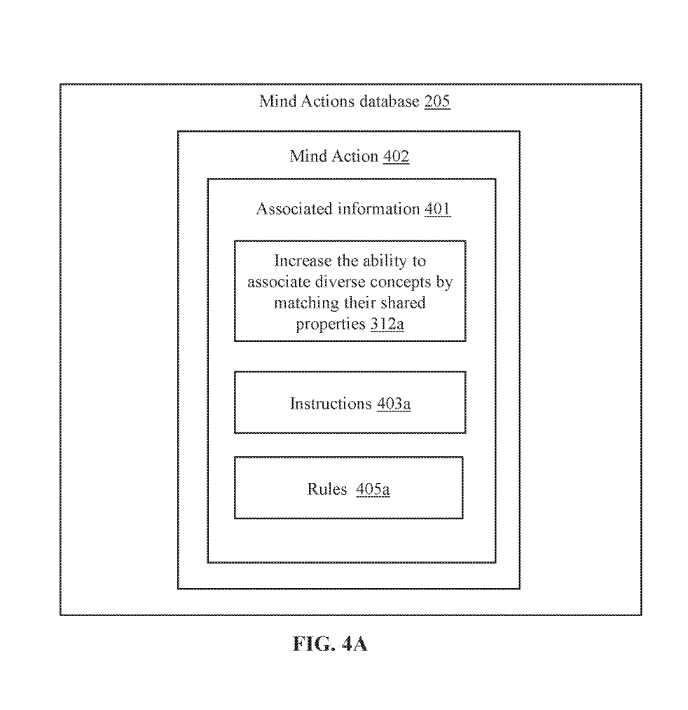

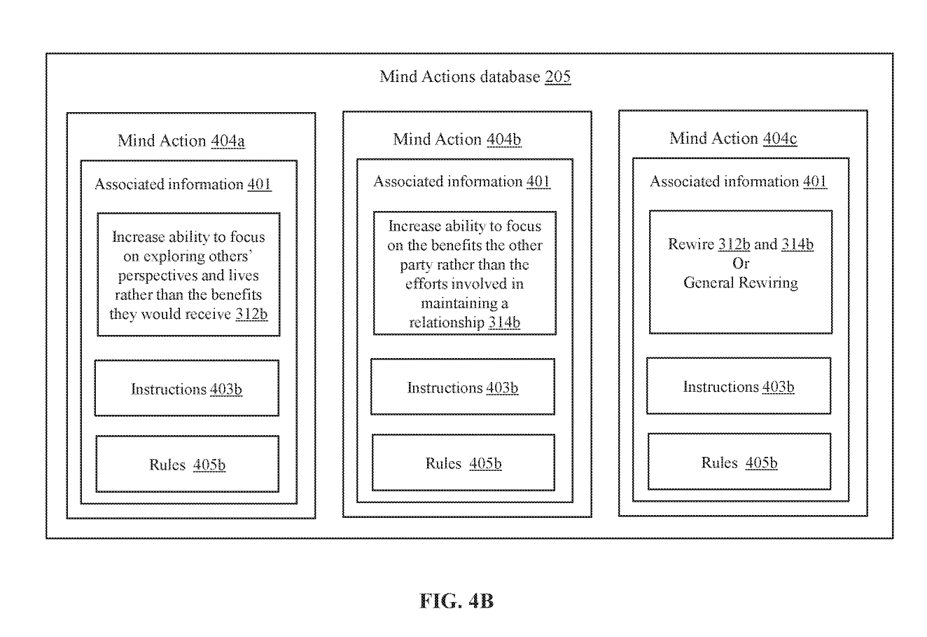

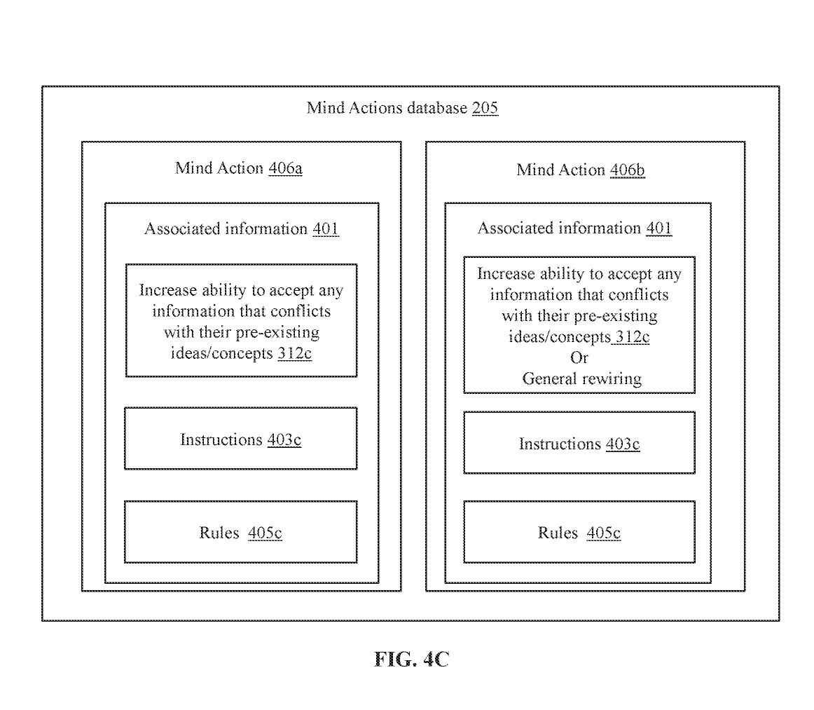

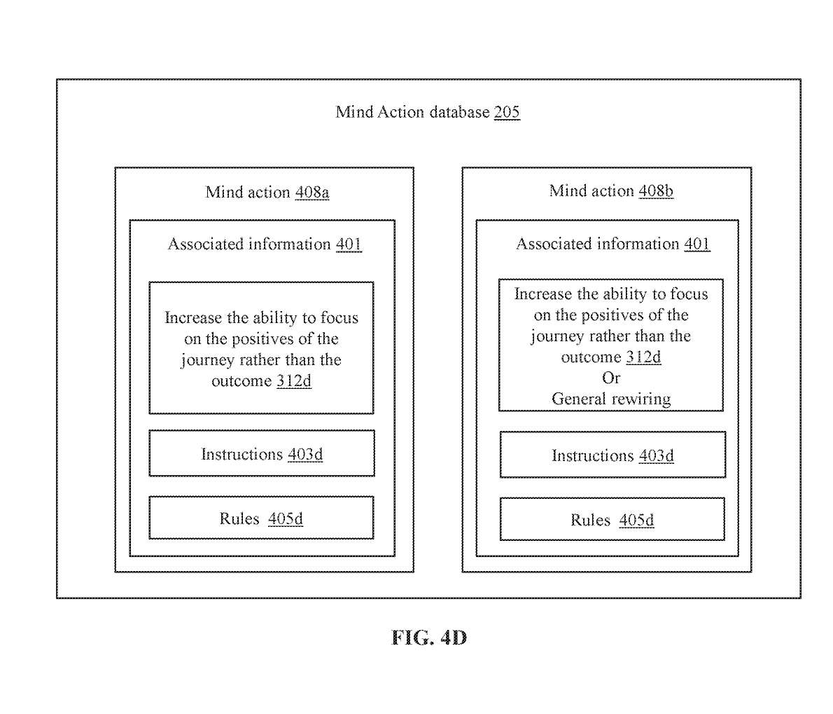

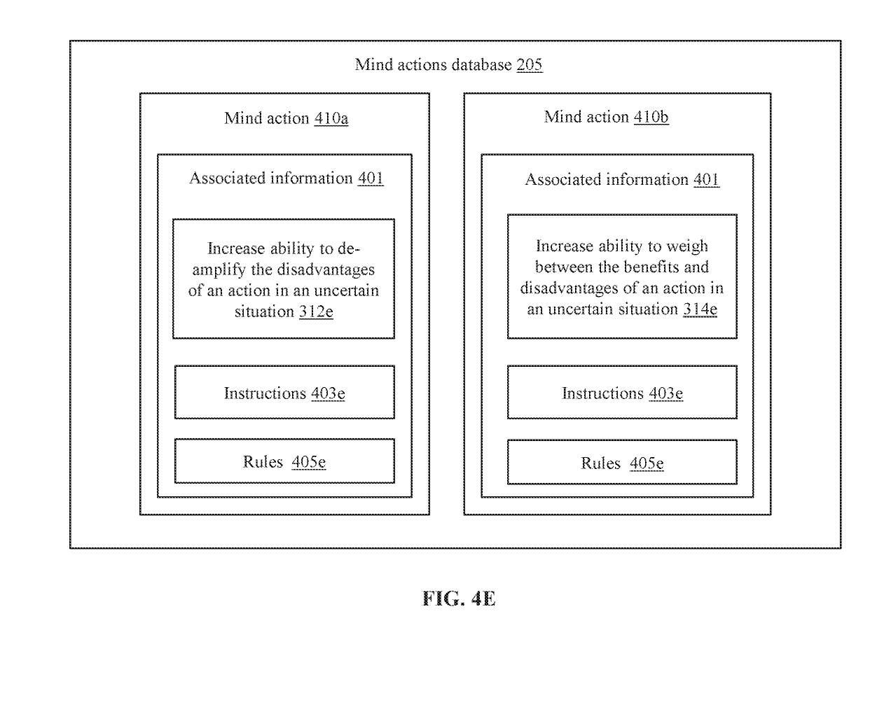

Referring to FIGS. 4A-4E, in an embodiment, each mind action (402-410) may include associated information 401. As an example, a mind action (e.g. 402) may be capable of achieving more than one type of brain rewiring. Each mind action includes data indicating the brain rewiring(s) 312 and 314, it is capable of achieving, so that the activity module 200 can opt to present a choice of one or more actions, which has the capability to achieve the brain rewiring, which the activity module 200 is attempting to achieve.

The associated information 401 may further include instructions 403 to be followed by the user to perform mind actions 402-410. Associated information 401 may additionally include one or more rules 405. Examples of rules 405 include rules for performing each action, rules to proceed to a higher level, scoring method in each level and time assigned to each level to reach the end of the level, among others.

In the example presented in FIG. 4A, with regards to creativity 216, a mind action 402 is included in the mind action database 205. The action 402 may be used by the activity module 200 to enhance brain wiring 228a by rewiring the brain to increase the ability to associate diverse concepts by matching their shared properties 312a. Mind action 402 is performed in a real world-environment.

Mind action 402 is called “connecting to one's past” and is designed to increase the ability to associate diverse concepts by matching their shared properties 312a. The action 402 may be provided in Table 1, where there are options for the user to note improvement percentage, level of action, routine and explanation. Example of the table is shown below.

TABLE 1

| Action | Improvement | Level of | Action | |
|---|---|---|---|---|
| Name | Percentage | Action | Routine | Action explanation |
| Connect- | | | | We can remember various |
| ing to | | | | concepts and information |
| one's | | | | present in the world but |
| past | | | | connecting them together |
| memories | | | | is difficult. This mind |
| | | | | action will help you to |
| | | | | find out shared properties |
| | | | | between specific memories |
| | | | | and general memories/new |
| | | | | information. |

An example of the mind action 402 is provided. The user may be instructed to think about a past memory and connect the memory to a current subject.

### Example

Connecting your past:
Screen 1: Think about one of the subjects you liked to study during college.
Write down the name of the subject
Example: Immunology
Screen 2: Find the shared properties between the subject you wrote and banking. Write down all the points

### Example: Immunology and Banking

Shared properties: Protection, a system, enemy attack, management, recovery, regulations, limits

In an embodiment, the activity module 200 may provide instruction 403a for a habit formation for the mind action 402, which is connecting to one's past. The habit formation may include a “Cue—Routine-Reward”. Example of a “Cue—Routine-Reward” may include:

Cue—Before watching TV
Routine—Carry out the action

### Reward—Watch TV

In the example presented in FIG. 3B, with regards to ability to network 218, mind actions 404a and 404b may be designed to enhance brain wirings 228c, 228d by rewiring the brain to increase ability to explore the perspectives and lives of other individuals rather than thinking of their own benefits 312b and to increase ability to focus on the benefits of the relationships to the other party rather than the efforts of maintaining a relationship 314b respectively. Action 404c may be a general mind action regardless of any specific wiring.

Action 404a is called reflecting and learning and may be directed at increasing ability to explore the perspectives and lives of other individuals rather than thinking of their own benefits 312b. Action 404b is called reconsider your flow of thoughts and may be directed at increasing ability to focus on the benefits of the relationships to the other party rather than the efforts of maintaining a relationship 314b. Action 404c is called seeing things from the other person's perspective and may be common to both rewiring 312b and 314b. All the actions are performed in a real-world environment.

Actions 404a, 404b and 404c may be provided in Table 2 as shown below.

TABLE 2

| Psychological | Total | Simplicity of the | | | |
|---|---|---|---|---|---|
| Action | Effect | action for the | | | Half |
| (Name) | size | user out of 10 | Duration | Description | Life |
| Reflecting | 10% | 6 | Once a | By writing the past situations | 4 |
| and Learning | (once a | | week | which made you poor at | weeks |
| | week for | | | networking and reflecting on them | |
| | 13 weeks) | | | is an effective way of dealing with | |
| | | | | them. It will help you stay open | |
| | | | | when such situations occur in the | |
| | | | | future. Spend at least half an hour | |
| | | | | carrying out this activity every | |
| | | | | week. | |
| Reconsider | 35% | 6 | 15-30 | Sometimes, there are more ways | 4 |
| your flow of | (once a | | minutes | of looking at a situation than the | weeks |
| thoughts | week for | | (once a | way you do. The best way is to | |
| | 6 weeks) | | week) | look at the benefits of the | |
| | 26001 | | | relationship to the other party in | |
| | | | | forming a good network, thereby | |
| | | | | making you feel more positive to | |
| | | | | predict a realistic outcome. Spend | |
| | | | | at least half an hour carrying out | |
| | | | | this activity every week. | |
| Seeing things | 15.00% | 5 | To be | To understand others, you have to | 4 |
| from the other | (Once a | | done | think beyond yourself and your | Weeks |
| person's | week for | | every day | own benefits/concerns. Once you | |
| perspective | 12 weeks) | | for at | see beyond your own world, you'll | |
| | | | least 10 | realize that there's so much to | |
| | | | minutes. | discover and appreciate! This will | |
| | | | | in turn help you deal with others | |
| | | | | in approachable manner. To be | |
| | | | | done every day for at least 10 | |
| | | | | minutes. | |

An example of action 404a, “reflecting and learning”, is provided. On a first screen, instruction 403b may be provided to the user to write about any past interaction that the user had with a new person, off late. Instructions 403b may require the user to pick a new person each time the action 402a is carried out.

### Example

When you met one of your mutual friend.

On a second screen, the user may be instructed to write about the conversation the user had and the new perspectives received from that conversation.

### Example

I realized that everyone in this world is going through their own battle. Nobody's life is easy.

On a third screen, the user may be instructed to think of way how the user can be of help to the individual the user met.

### Example

I can be of support to this person, as she is going through a difficult time in her life. As I know someone who have gone through the same difficulty in the past, so I can help my friend by getting know how my other friend went through the same issue.

On a fourth screen, the user may receive a message “so, this way, you can think of understanding other individual's lives and understand how you can be of help to them. Doing good is contagious.”

An example of action 404b, “reconsider your flow of thoughts”, is provided. On a first screen, instruction 403b may be provided to the user to write about any past interaction that the user had with a new person, off late. Instructions 403b may require the user to pick a new person each time the action 404a is carried out.

### Example

You met a mutual friend in the metro station

On a second screen, instruction 403b may be provided to the user to write in a box provided, the benefits of the relationship to the other party.

### Example

You come to know that your mutual friend is trying to find an appropriate course in the field you are interested in. So, you can help the friend in finding the right course in the right college. Instead of always looking at the efforts you have to put in maintaining the relationship, make an effort to look at benefits of the relationship the other party will receive as that is the core of forming a meaningful relationship.

An example of action 404c, is provided. On a first screen, the user may receive a message, as seen “seeing things from the other person's perspective is simply recognizing emotions in others, and being able to “put yourself in another person's shoes”—understanding the other person's perspective and reality. Once you see beyond your own world, you'll realize that there's so much to discover and appreciate!”

On a second screen, the user is instructed to put aside his viewpoint, and try to see things from the other person's point of view and write a situation where the user was in a networking situation in the past.

### Example

You had attended a school reunion where you met your schoolmates.

On a third screen, the user is instructed to examine his attitude. A question may be asked as follows, “Are you more concerned with getting your way, winning, or being right? Or, is your priority to find a solution, build relationships, and accept others? Without an open mind and attitude, you probably won't have enough room for forming meaningful relationship.”

### Example

The main aspect of school reunions is that you get to catch up with your old schoolmates and get to know about their lives. Then maybe see how you can be of help to them.

On a fourth screen, the user is instructed to listen to an entire message that the other person is trying to communicate.
a. Listen to what is being said, and what tone is being used?
b. See what the person doing with his or her body while speaking?
c. Do you sense that the person is not communicating something important?
d. What do you think the other person feels?

On a fifth screen, the user is instructed to practice these skills when interacting with people. You'll likely appear much more caring and approachable—simply because you increase your interest in what others think, feel, and experience. It's a great gift to be willing and able to see the world from a variety of perspectives—and it's a gift that you can use all of the time, in any situation.

Referring to FIG. 4C, with regards to open-mindedness 220, action 406a may be directed at rewiring 312c the brain to increase ability to accept any information that conflicts with their pre-existing ideas/concepts. Action 406b may also be directed at rewiring 312c the brain to increase ability to accept any information that conflicts with their pre-existing ideas/concepts. Action 406b may further be a general mind action regardless of the wiring. Actions 406a and 406b are performed in a real-world environment.

Action 406a is called seeing things from the other person's perspective and may be directed at increasing a user's ability to accept any information that conflicts with their pre-existing ideas/concepts 312c. Action 406b is called learning to see things differently and may not be specific to any wiring or may be specific to wiring 228e.

Actions 406a and 406b may be provided in Table 3 as shown below.

TABLE 3

| Psychological | Total | Simplicity of the | | | |
|---|---|---|---|---|---|
| Action | Effect | action for the | | | Half |
| (Name) | size | user out of 10 | Duration | Description | Life |
| Seeing things | 10% | 6 | Once a | By writing the situations which | 4 |
| from the | (once a | | week | make you closed and reflecting | weeks |
| other person's | week for | | | information that conflicts your | |
| perspective | 13 weeks) | | | viewpoint and accepting it is an | |
| | | | | effective way of dealing with | |
| | | | | them. It will help you stay | |
| | | | | opened when such situations | |
| | | | | occur in the future. Spend at | |
| | | | | least half an hour carrying out | |
| | | | | this activity every week. | |
| Learning to | 16% | 5 | To be done | Seeing different perspectives will | 4 |
| see things | (once in | | during a | help one to show that things are | weeks |
| differently | every 3 | | situation | often not as they first seem, and | |
| | weeks) | | when you | there's almost always a different | |
| | | | start having | perspective. Carry out the action | |
| | | | suspicious | for at least 15 minutes every | |
| | | | thoughts for | morning | |
| | | | at least 15 | | |
| | | | minutes in | | |
| | | | the morning | | |

An example of action 406a is provided. On a first screen, the user is instructed to write a situation in the past where the user was closed minded.

### Example

Your nephew announced that he is planning to live in with his girlfriend.

On a second screen, user is instructed to write the reasons why the idea/concepts were conflicting to the user's pre-existing belief.

### Example

You feel that your nephew is not matured enough to stay alone with a girl and this means he is not being completely committed to this girlfriend. This relationship will be viewed negatively by your relatives.

On a third screen, user is instructed to make an effort to analyze and write the positives of the idea/concepts that he rejected.

### Example

By living with each other, your nephew can get to know his girlfriend more closely and understand each other's habits, behaviors when in crisis and get adapted to each other.

On a fourth screen, user is asked if after this analysis, the user thinks the idea/concept was worth accepting. The user should answer in either “Yes” or “No”. The activity module 200 enables the user to select either of the options.

An example of action 406b is provided. On a first screen, the user is instructed to write a situation where the user was closed minded in the recent time.

On a second screen, user is instructed to type the wider view in a particular situation by considering the view of the self, others, outsider and through a wise mind.

Self: What am I reacting to? What does this situation mean to me?
Others: What would this look like to others involved?
Outsiders: How would this seem to someone outside the situation—not emotionally involved?
Wise Mind: What would be the best thing to do—for me, for others, for this situation?

### Example

Self: My friend has not called me for one week. She didn't call me back. I'm not worth bothering about. No-one likes me anyway.
Others: Maybe she was really busy with her college assignments.
Outsider: Maybe the situation is being exaggerated.
Wise Mind: It would be better for me to call and check if anything is wrong before jumping into conclusions.

On a third screen, user receives a message as seen, “so it is helpful in seeing your issue in a wider view by considering how differently you see the situation and how others see it.”

In an example presented in FIG. 4D, with regards to passion 222, an action 408a can be used by the activity module 200 to improve brain wiring 228f by rewiring the brain to increase the ability to focus on the positives of the journey rather than the outcome 312d. Another action 408b may also be used by the activity module 200 to improve brain wiring 228f by rewiring the brain to increase the ability to focus on the positives of the journey rather than the outcome 312d. Further, action 408b may be a general action not specific to the wiring. Actions 408a and 408b are performed in real-world environment.

Action 408a is called “Reflecting and Coping” and may be designed to increase the ability to focus on the positives of the journey rather than the outcome 312d. Action 408b is called “Living in the Present” and may be a general mind action.

Actions 408a and 408b may be provided in Table 4 as shown below.

| Psychological | Total | Simplicity of the | | | |
|---|---|---|---|---|---|
| Action | Effect | action for the | | | Half |
| (Name) | size | user out of 10 | Duration | Description | Life |
| Reflecting | 10% | 6 | Once a | By writing down the situations in | 4 |
| and Coping | (once a | | week | the past where your passion for an | weeks |
| | week for | | | activity or task reduced and | |
| | 13 weeks) | | | reflecting on the things which you | |
| | | | | would have experienced if you had | |
| | | | | continued with the activity. This | |
| | | | | helps you to look concentrate on | |
| | | | | the positives of the journey rather | |
| | | | | than just the outcome of the | |
| | | | | activity or task and thereby making | |
| | | | | you more passionate. Spend at least | |
| | | | | half an hour carrying out this | |
| | | | | activity every week. | |
| Living in | 27% | 7 | 15 minutes | Awakening to the present moment | 1 |
| the Present | (Once a | | (preferably | and all the thoughts and sensations | week |
| | week for | | in the | that accompany it, is the key to | |
| | 5 weeks) | | morning | living a fulfilling life. The present | |
| | | | or night) | moment is the only time you have | |
| | | | | control over your life and so make | |
| | | | | the best use of it. Spend at least | |
| | | | | fifteen minutes every day, | |
| | | | | preferably in the night, to listen to | |
| | | | | the audios. | |

An example of action 408a is provided. On a first screen, the user is instructed to write a situation in the past where the user was interested in an activity but couldn't pursue.

### Example

You joined a dance class but did not continue.

On a second screen, user is instructed to write down the thought process he had when he started that particular activity.

### Example

You wanted to be a successful dancer. You wanted to be like your idol.

On a third screen, user is instructed to make an effort to analyze and write down the positives the user could have picked while pursuing that activity. The positives of the idea/concepts that he rejected.

### Example

You were best in some of the moves. Your friends always admired you. You were training them when there were no mentors.

On a fourth screen, user is asked if after this analysis, the user thinks he could have been more passionate with that activity. The user should answer in either “Yes” or “No”. The activity module 200 enables the user to select either of the options.

With regards to action 408b, the user is instructed to view one or more videos in a sequential order, among a plurality of URLs linked to the videos.

Referring to FIG. 4E, with regards to ability to take risks 224, actions 410a-410b are included in the mind actions database 205. Actions 410a-410b can be used by the activity module 200 to improve brain wirings 228g and 228h by rewiring the brain to increase ability of users to de-amplify the disadvantages of an action in an uncertain situation 312e and increase ability of users to weigh between the benefits and disadvantages of an action in an uncertain situation 314e respectively.

Action 410a is called “Time travel” and is designed to increase ability of users to de-amplify the disadvantages of an action in an uncertain situation 312. Action 410b is called “Decisive” and is designed to increase ability of users to weigh between the benefits and disadvantages of an action in an uncertain situation 314e.

Actions 410a and 410b may be provided in Table 4 as shown below.

TABLE 5

| Psycho- | | | | |
|---|---|---|---|---|
| logical | Total | | | |
| Action | Effect | | | Half |
| (Name) | size | Duration | Description | Life |
| Time | 3% per | Thrice | We all do take risks in life, | 4 |
| Travel | action | every | few important and few silly. | weeks |
| | | week | This action will enable you | |
| | | | to look back in your life and | |
| | | | de-amplify the disadvantages | |
| | | | of taking a risk. This action | |
| | | | will increase your ability to | |
| | | | take valuable risks in your life | |
| | | | by changing your bias towards | |
| | | | the disadvantages of that | |
| | | | action. | |
| Deci- | 5% per | Thrice | Usually we face challenges each | 4 |
| sive | action | every | and every day of our lives and | Weeks |
| | | week | we make decisions to encounter | |
| | | | them. This action will enable | |
| | | | you to balance your risk-taking | |
| | | | ability by comparing the | |
| | | | benefits and disadvantages if | |
| | | | you had taken risks in a | |
| | | | situation that has already | |
| | | | passed. | |

An example of action 410a is provided. On a first screen, the user is instructed to think and write down any situation that occurred in the past where the user has taken risk and it worked in his favour. The user is also instructed to think of all the reasons about why he took that risk. How did he manage to de-amplify the disadvantages of that action before he took it?

### Example

Situation: I took a decision to start a campaign for sustainable development in my college days.
Reasons I took the risk: I knew it is for a good cause and even if it won't get accepted by people, it is not going to do any harm to me.

On a second screen, user is instructed to write down one instance that happened in school/college/job where the user took a risk but it didn't pay off. The user is required to pick a different situation each time the action is carried out. The user is also instructed to write down how he overcame the disadvantages that he may have faced as an outcome, since the risk did not pay off.

### Example

Situation: I took a risk of not studying a particular module from one of the subjects before examination.
Overcoming the disadvantage: I decided to study all the module from next time as I couldn't answer many questions during the exam.

On a third screen, user is instructed to pick and write about any event or situation that happened recently in life where the user wanted to take a risk but did not. It could be anything such as changing jobs/presenting an idea/start up idea. The user is required to pick a different situation each time the action is carried out. The user is also instructed to write down all the facts that support his idea of taking a risk and all the facts that de-amplify the disadvantages of that action.

### Example

Situation: I was about to explain my patentable idea in front of an Investor but I dint tell
Support for the risky decision: Investor might invest in my idea, He might give me few valuable suggestions, it might increase my value in front of him.
De-amplification of Disadvantage: Even if he will try to steal my idea, it is going to be hard for him, even if he won't invest I might get various other chances of pitching.

An example of action 410b is provided. The activity module 200 shows the statements on a first screen (sequentially-one at a time/skip) followed by an empty box specified with “benefits and disadvantages” as a heading. This should be shown per action.

The first screen instructs the user to write down the benefits and disadvantages of these actions, which have already occurred in the user's life.
Choosing a new restaurant for a dinner
Downloading a new application in your mobile
Trying a new route to reach your office or home
New Idea that you shared with colleagues/friends
Questioning higher authority on their decision
A challenging task

### Example

Action: Choosing a new restaurant for dinner
Benefits: I loved the taste of food, got an amazing place to hang out, I can suggest my friends to go there
Disadvantages: I have to waste my time to find this new restaurant.

On a second screen, user is instructed to write down an important decision that he took in life, which involved some amount of risk. The user is required to pick a different decision each time the action is carried out. The user is also instructed to write down all the benefits and disadvantages of that decision which he took.

### Example

Situation: Joined a company which was not in my field
Benefits: Learned new skills, increased my openness, found new research paths, gained divergent skills
Disadvantages: Felt difficult to adapt in the new field, had to work very hard than my colleagues.

On a third screen, user is instructed to pick and write about situation where the user turned down an action that involved risk. The user is required to pick a different important situation each time the action is carried out. The user is also instructed to write down all the benefits and disadvantages if he had taken that risk.

### Example

Situation: Joining a new start up
Benefits: Quick promotion, lot to learn, Train people
Disadvantages: No security of job, value reduction in profile

In an embodiment, the activity module 200 may provide instruction 403e for a habit formation for the mind action 410a, which is called “Time travel”. The habit formation may include a “Cue—Routine-Reward”. Example of a “Cue—Routine-Reward” may include:

Cue—Before watching TV

Routine—Carry out the action

Reward—Watch TV

### Actions Database 206

The actions database 206 includes information corresponding to a plurality of real-world activities or sets of real activities. Real-world activities may include activities that are performed in a real-world environment, as opposed to the digital games played in the virtual world (ex: games included in the collection of games 204). Examples of real-world activities include, but not limited to, counting the number of restaurants that are on the way back from one's office to home, interacting with a neighbor, interacting with a friend's friend, asking them their names, addresses, hobbies and profession, among others.

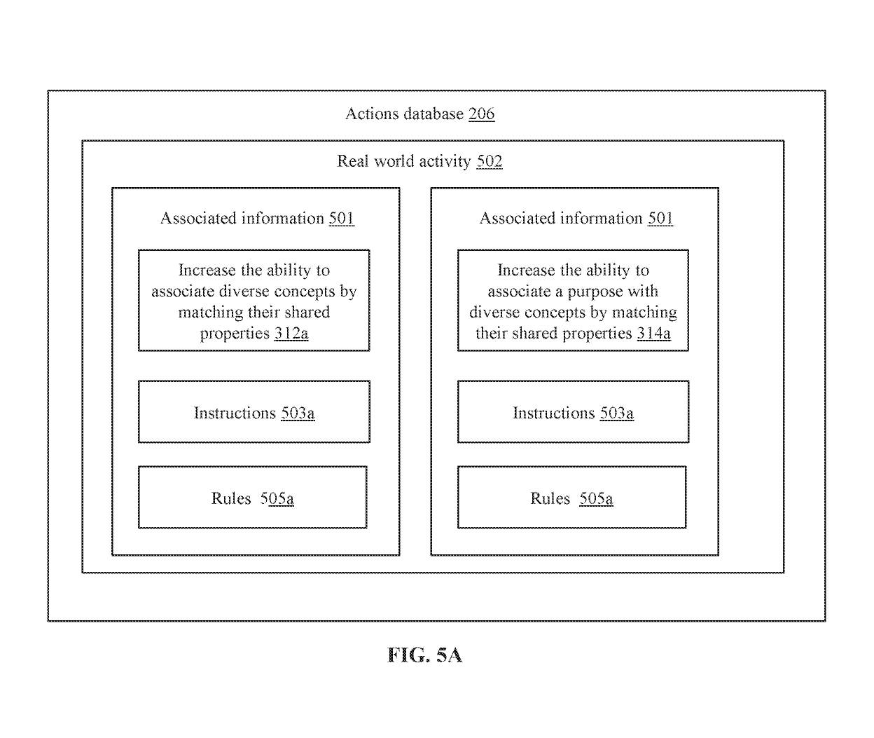

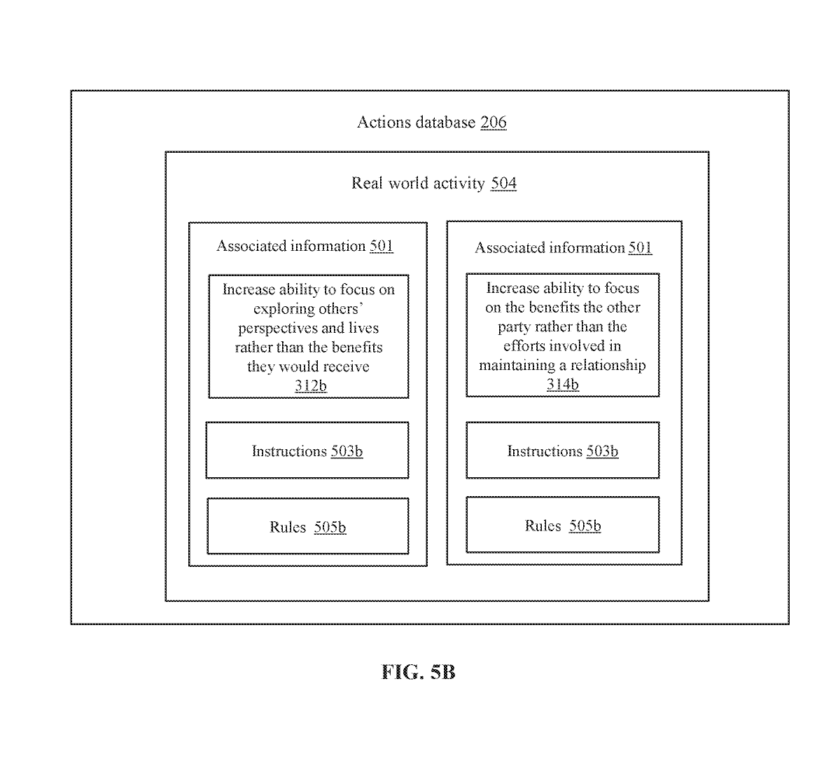

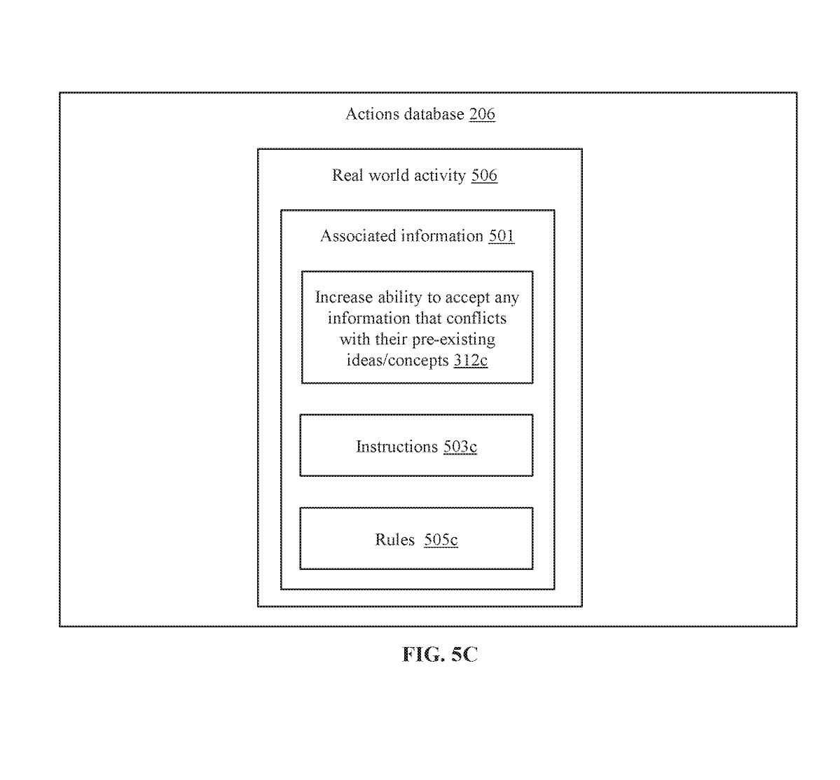

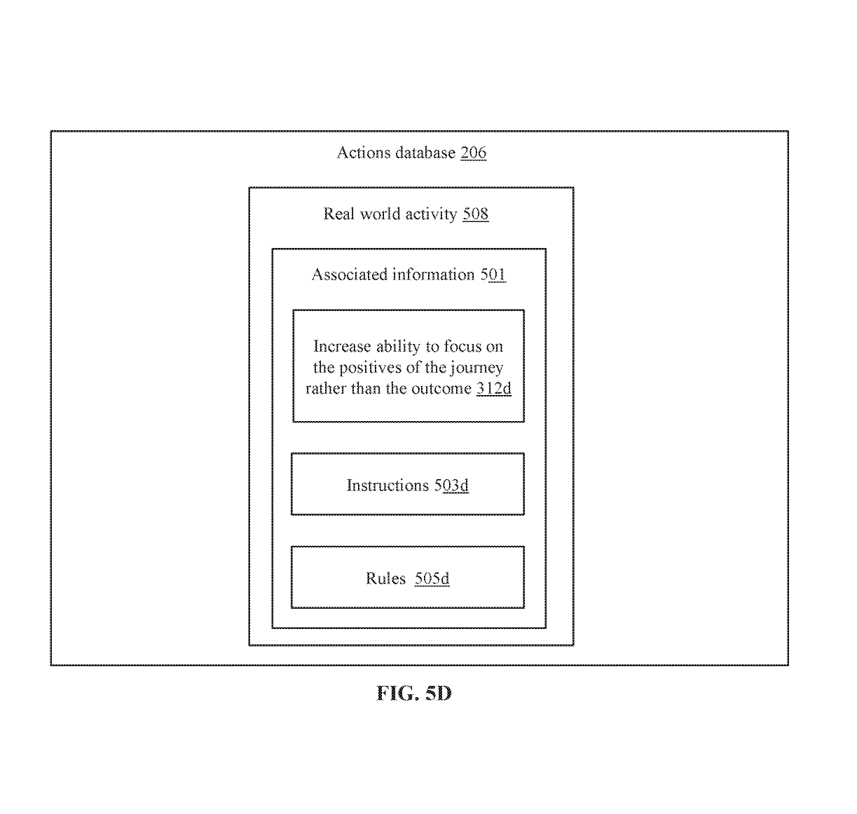

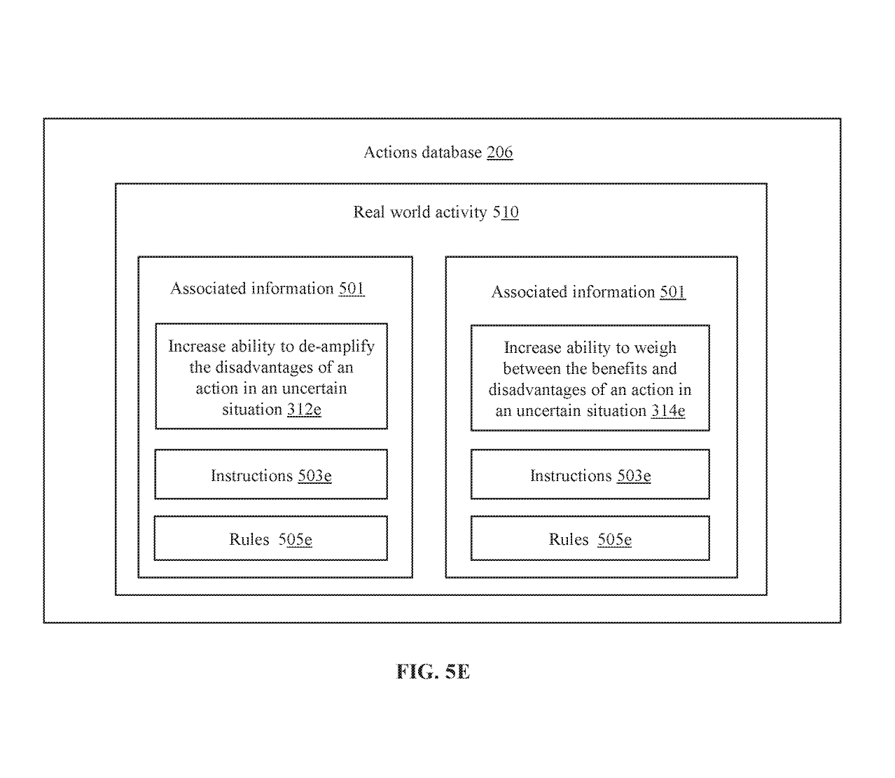

Referring to FIGS. 5A-5E, each of the real-world activities 502-510 or sets of real-world activities 502-510 may be used by the activity module 200 based on the brain rewiring, which the real-world activity 502-510 is capable of achieving.

Each real-world activity 502-510 may include associated information 501. As an example, a real-world activity 502 may be capable of achieving brain rewiring 312a and 314a. Likewise, 504 may be capable of achieving brain rewiring 312b and 314b, 506 may be capable of achieving brain rewiring 312c, 508 may be capable of achieving brain rewiring 312d and 510 may be capable of achieving brain rewiring 312e and 314e.

Each real-world activity 502-510 includes data indicating the brain rewiring(s) 312, 314 it is capable of achieving, so that the activity module 200 can opt to present a choice of one or more real-world activities 502-510, which has the capability to achieve the brain rewiring, which the activity module 200 is attempting to achieve.

Associated information 501 may further include instructions 503 to be followed by the user to perform the real-world activity 502 or a set of real-world activity 502-510. The associated information 501 may additionally include one or more rules 505. Examples of rules 505 include rules to proceed to a higher level, scoring method in each level and time assigned to each level to reach the end of the level, among others.

Referring to FIG. 5A, with regards to creativity 216, real-world activity 502 is used by the activity module 200 based on the brain rewiring, which the real-world activity 502 is capable of achieving. The real-world activity 502 may be designed rewire the brain to increase the ability to associate diverse concepts by matching their shared properties 312a and increase the ability to associate a purpose and diverse concepts by matching their shared properties 314a.

The real-world activity 502 may be presented to the user after the user has at least participated in the mind action 402 to a predefined extent, that attempt to rewire 312a and 314a, the first and the second brain wirings 228a and 228b respectively.

In level 1, on a first screen, the activity module 200 may present tasks listed below and may present them sequentially.
In your daily environment, observe those individuals who come up with amazing concepts, which could be for organizational benefit, entertainment, business purpose, or social cause. Understand the purpose of the idea/concepts and associated fields or concepts with the idea. Count those numbers of people that you see today.
In your daily environment, (Virtual or real) observe those individuals whose new concepts have changed the society and a complete generation. Understand the purpose of the idea and associated fields or concepts with the idea. Count those numbers of people that you see today.

### Example: Click a Link Below

In your day to day life, observe any new technology in the market. Understand the purpose of the idea and associated fields or concepts with the idea. Count the number of products which have used latest technologies.
Watch any movie that has shown a creative concept or has creatively executed the main idea of the film. While watching observe the concept, people involved as well. A few examples are: The Imitation game, A Beautiful mind, Theory of everything, How Einstein came up with E=mc2
In your day to day life, observe for any kind of problem that require a creative solution and make a note of it. Count those numbers of problems that you encounter in a day

On a second screen, the user is instructed to enter the number of individuals/innovations/products/problems which filled the above criteria, at the end of the day.

In a second level, a first screen instructs the user to perform the following tasks:
Find out one of the products in your field which is new and has a lot of potential to solve many problems. Find out over the internet by watching ted talks or by searching for authentic information, the goal of the product and how they added functionalities in the product.
Talk to one of your friend who works in a different company than yours and ask him about one of the products of his company. Find out what it solves, and how they came up with such an idea.
Search for an individual in your organization or in your friend circle who recently talked about a new concept and business idea. Ask him about how he came up with the idea, what it solves and what are the different fields that he associated with the idea.
Find out top ten new business ideas. Pick as many as you can and find out the purpose of the business and how they came up with the services or products that serve their business.

The activity module 200 may further instruct the user to rate the level of learning on creativity by the end of the day (1 being low level of learning and 10 being high level of learning).

In level 3, on a first screen, the activity module 200 may present a list of tasks and present them sequentially.
Each and every day we face traffic problems and day by day it's getting worse. Think about an idea which will reduce the amount of traffic in the city and will continue to do so in the future. Explain your idea to one of your close friend and ask for feedback.
One of the major problems in professional world is to keep updated with new research and current innovations in the field. Come up with an idea or a concept which will solve this problem. Explain your unique solution to one of your family member and get feedback
There are so many homeless people in the world, starving and sleeping under the sky. Think about an idea which will use the ability of those people and will provide them shelter, food and source of income. Explain your idea to one of your family member.
Think about your country and the primary problems people facing in day to day life or the primary problems your country is facing. Come up with a concept to solve the problem of your nation. It could be anything related to Agriculture, transportation, sharing economy etc.

Talk to one of your friend about your ideas and ask for feedback.

On a second screen, the activity module 200 provides audio options to speak about an idea for each the tasks shown sequentially.

In level 4, on a first screen, the activity module 200 may present a task.
Conceptualize a complete new idea which can solve one of the problems in business, society or in your field. It could be anything such as brand innovation, product innovation, and scientific theory. Talk to one of your mentor in life. Take the feedback and work towards it until you are satisfied by it. Explain about your new idea to one of your friend who is open to new ideas.

On a second screen, the activity module 200 provides a scale to the user and instructs the user to rate the level of complexity of the idea or concept (1 being an easy concept and 10 being the toughest concept)

In level 5, the user may be instructed to mentor another individual who is less creative (and who wants to change) and guide them on the skills that the user has learned. This person could be the user's friend/family member or colleague.

Referring to FIG. 5B, with regards to ability to network 218, real-world activity 504 is used by the activity module 200 based on the brain rewiring, which the real-world activity 504 is capable of achieving. The real-world activity 504 may be presented to the user after the user has at least participated in mind actions (404a, 404b, 404c) to a predefined extent that attempt to rewire the brain wirings 228c and 228d.

Real-world activity 504 may be designed to rewire the brain to increase a user's ability to explore the perspectives and lives of other individuals rather than thinking of their own benefit 312b and increase a user's ability to focus on the benefits of the relationships to the other party rather than the efforts of maintaining a relationship 314b.

The activity module 200 may recommend tasks to be performed by the users in one or more levels. Instructions 503b may require the user to carry out the action every day. According to rules 505b, each level has to be repeated 5 times successfully (where there is more than one alternative in the level), and 3 times successfully (where there is only one alternative) before the next level unlocks.

In level 1, the user is instructed to choose a quiet place to sit in and close the eyes and imagine in detail what is shown below. The activity module 200 has to choose one of the following options shown below sequentially and display it to the user. The user is instructed to perform each task as shown by the activity module 200. Audio is enabled for this option.
Imagine you are joining a new company. Imagine yourself being curious about each person in the gathering and try to make an effort to go ahead and talk to each of the individual present in that place instead of being overwhelmed by lot of people. Try to gather as many perspectives as you can rather than looking for the benefits you are going to receive instead imagine yourself helping any individuals you can. Imagine yourself being able to have a great conversation being calm and composed.
Think of situation where you are meeting new people in a wedding. When you start a conversation with someone new, make sure to make them feel important and listen to what they have and ask appropriate questions that show that you are listening. Imagine the person feeling really comfortable talking to you and you are building a healthy rapport with the person. You are being aware of new perspectives in life by talking to the person. Imagine yourself carrying out this activity with great ease and feeling calm.
Think of a situation in the future, where you will be in social gathering like workshop or conference. When you are talking to someone, try to be genuine when you are talking to someone by being interested as it is important to be interested before being interesting. And imagine yourself maintaining the relationship you have established by sending mails or calling them up. Imagine you feeling very comfortable making effort to maintain the relationship you established.

In level 2, the user is shown the following tasks sequentially. The user is instructed to perform each task as shown by the activity module 200.
Today pick a celebrity who you think is good at networking, and then observe what are the things they do that make them to be good at networking. You can watch their talks online.
Today pick a person who you think is poor at networking. Observe why the individual is poor at networking and how that is being disadvantageous to that individual.
Today pick a person from your workplace/institutions who you think is good at networking. Make an effort to observe how the individual approaches people and the efforts they make to continue the relationship they have established. You can also have conversation with these individuals and try to imbibe their qualities.

In level 3, on a first screen, the user is shown the following tasks sequentially. The user is instructed to perform each task as shown by the activity module 200.
When you are having a conversation with someone in a conferences/seminar, attempt to listen to the opposite person with a constant eye contact rather than just thinking of how to reply to that person. One reason we lose some of network is because, we are just always only bothered about sharing about our venture.
When you meet someone new in a party, start off by knowing the person and try to ask open ended questions as this will let to you knowing various perspectives of that person.
Being generous is the point. When you are in a networking event, spot the loners, and try to start a conversation and see how you can be of help to them.
Sharing is caring. When you meet people in a family gatherings, try to connect people who you know and who can be of help to each other.
When you are travelling on a daily basis in public transport, instead of sitting idle, it is a better idea to think of networking. Start off by talking to them and try to see their perspectives. Try to maintain the relationship you have established. Check how you can be of benefit to that individual.

On a second screen, a scale is presented to the user, wherein the user has to rate his comfort level of carrying out the action on a scale of 1-10 (1 being the low and 10 being the highest), by the end of the day.

In level 4, the user is shown a task. The user is instructed to perform the task as shown by the activity module 200.
When you are in a situation where you would be meeting new people. Make an effort to start a conversation with some of them. If you've had a great exchange, ask your conversation partner the best way to stay in touch. Get in touch within 48 hours of the event to show you're interested and available by sending an email or by calling them or connecting in a social media and reference something you discussed, so your contact remembers you. Pick a new person whenever you carry out this action.

On a second screen, a scale is presented to the user, wherein the user has to rate his comfort level of carrying out the action on a scale of 1-10 (1 being the low and 10 being the highest), by the end of the day.

In level 5, the user is instructed to mentor another individual who is poor at networking (and who wants to change) and guide them based on the skills that the user has learned. This person could be a friend/family member or colleague.

Referring to FIG. 5C, with regards to open-mindedness 220, real-world activity 506 may be used by the activity module 200 based on the brain rewiring, which the real-world activity 506 is capable of achieving. The real-world activity 506 may be presented to the user after the user has participated in mind action (406a, 406b) at least to a predefined extent.

The real-world activity 506 may be directed at rewiring 312c the brain wiring 228e to increase ability to accept any information that conflicts with their pre-existing ideas/concepts 312c.

Instructions 503c may require the user to carry out the action every day. According to rules 505c, each level has to be repeated 5 times successfully (where there is more than one alternative in the level), and 3 times successfully (where there is only one alternative) before the next level unlocks.

In level 1, the user is instructed to choose a quiet place to sit in and close the eyes and imagine in detail what is shown below. The activity module 200 has to choose one of the following options shown below sequentially and display it to the user. The user is instructed to perform each task as shown by the activity module 200. Audio is enabled for this option.
Think of an argument that you might have with your friend about new method studying, instead of only thinking about your viewpoint, try to understand why they are stressing to you about it. Make an effort to see the positives of their viewpoint which could be that the new method of studying is time saving and the grasping of the topic much easier and try to validate it to them. Imagine yourself focusing on the benefits of accepting the new idea proposed by your friend.
Think of a topic on which you might have an argument with your colleague. The argument is about a different way of completing a project. So you argue on the ways you strongly believe in and your colleague argues for the other perspective. Instead of getting annoyed and being judgmental, just take some time to calm down and try to understand why your colleague is trying to argue about his/her perspective and make an effort to validate those perspectives and try to see positives in his/her perspectives. The positives of the new way of working is that the implementation will be done sooner and it is more economical. Try to respect the other person's perspectives as this will reduce the arguments you have with the other individuals.
Imagine that your company comes up with new ideas/projects and you feel that the idea is not feasible, try to stop yourself from jumping to conclusions and be open to considering why the company has decided on the idea and try to put forth your concerns and wait for their solution to it. Being flexible is the secret to being open to new ideas. Attempt to work on the idea and see the advantages or merits of the idea. Any new ideas will be ambiguous but the ambiguity can be fun to work with.

In level 2, the user is shown the following tasks sequentially. The user is instructed to perform each task as shown by the activity module 200.
Today pick a famous celebrity who you feel is very open and make an effort to read on how the person views certain aspects.
Today choose an individual who is very closed as a person. Notice how the person is not flexible about certain aspects and how the person is handling arguments and how that is being disadvantageous to that individual.
Today choose someone who is more open than yourself. Try to observe how the person handles arguments and make an effort to talk to that person about their outlook towards life and various aspects. And also focus on how being open to diverse perspectives have been beneficial to that individual.

In level 3, on a first screen, the user is shown the following tasks sequentially. The user is instructed to perform each task as shown by the activity module 200.
When you are having a conversation with someone, attempt to listen to the opposite person rather than just thinking of how to reply to that person. One reason we are rigid is we are always forgetting to listen to the other person.
Try talking to new people every day and ask their views on different areas. You can learn something new from each person every day. Also try to discuss their views of certain areas where you feel you are being rigid. And make an effort to validate those perspectives.
Pick a topic to talk about with your close friend and choose the perspective you do not believe in. And attempt to come up with viewpoints of that perspective.
Pick a controversial issue you would like to discuss with someone. Before initiating the conversation, confess to them about your listening offense. Tell that person how you tend to close your mind, block and resist what the other person is saying. But tell him/her that you want to change this habit of yours and you will make an effort to listen to him/her with undivided attention and ask him/her if he/she is ready for this agreement. While listening, make an effort to listen completely, try to understand that person's perspectives. At the end of conversation, acknowledge and thank that person for speaking and listening.

On a second screen, a scale is presented to the user, wherein the user has to rate his comfort level of carrying out the action on a scale of 1-10 (1 being the low and 10 being the highest), by the end of the day.

In level 4, on a first screen, the user is shown the following tasks sequentially. The user is instructed to perform each task as shown by the activity module 200.
Read the daily newspaper and notice what part of the news you were being rigid about. Attempt to understand what makes you closed to that particular article and try to see the benefits of the articles rather than being closed.
Read about cultures and try to check what are the differences between your culture and other cultures. Focus on the positives that can be learned from the culture and how certain aspects can be included in your culture.
Explore new fields other than your own. And attempt to focus on the advantages of that field and how you can combine your field and the new field for a beneficial reason.
Throw yourself into new situations which is not your comfort zone. Putting yourself in an uncomfortable situation, you are challenging your mind and learning as you go.
Pick some opinions that you are very rigid about, focus on the negatives of holding that particular opinion strongly and view different perspectives related to that opinion.

On a second screen, a scale is presented to the user, wherein the user has to rate his comfort level of carrying out the action on a scale of 1-10 (1 being the low and 10 being the highest), by the end of the day.

In level 5, the user is instructed to mentor another individual who is closed-minded (and who wants to change) and guide them based on the skills that the user has learned. This person could be a friend/family member or colleague.

Referring to FIG. 5D, with regards to passion 222, real-world activity 508 is used by the activity module 200 based on the brain rewiring 312d, 314d, which the real-world activity 508 is capable of achieving.

The real-world activity 508 may be presented to the user after the user has at least participated in mind actions 408a, 408b to a predefined extent that attempt to rewire 312d, the brain wiring 228f. The real-world activity 508 may be designed to rewire the brain to increase ability to focus on the positives of the journey rather than the outcome 312d.

In a first level, the activity module 200 may provide instructions 503d, to choose a quiet place to sit in and close the eyes and imagine in detail what is shown in a list of tasks sequentially on a screen.
Imagine a situation where you are leading a group. Visualize the positives that you are experiencing. Ex: One of your employee got nominated for best employee award.
Your team gave a positive feedback on your managerial skills.
Imagine a situation where you have joined a hobby class. Visualize the positives that you experience while pursuing the hobby. Ex: You meet similar enthusiast from different background.
Your coach praised you for your hard work.
Imagine a situation where you are in a relationship which includes friendship, spouse etc. Visualize the positives that you are experiencing while being in the relationship. Ex: You had a splendid time with your friends during the drive.
Your spouse arranged a surprise party on your birthday.

In a second level, a list of tasks is sequentially shown one list on a first screen. Each first screen showing a task is followed by a second screen, wherein instructions 503d are provided to write down something about the task.

### Screen 1

Read stories of successful people who are passionate about their task/activity. Ex: Scientists, sportsman, musicians etc. Try to figure out the positives they focused during the journey.

### Screen 2

By the end of the day, please write down the number of articles/writings you read today. A box is provided for the user to tap on the correct number.

### Screen 1

In your environment, look for people who are passionate about what they are doing. Talk to them and know how they focus on the positives of their journey.

### Screen 2

Enter the number of people you observed today. A box is provided for the user to tap on the correct number.

### Screen 1

Watch a movie/play and observe how passionate the actors are about their roles. Try to read about them and how they are focused on the positives of their journey.

### Screen 2

Enter the number of such people you observed today. A box is provided for the user to tap on the correct number.

In a third level, a list of tasks is sequentially shown one list on a first screen. Each first screen showing a task is followed by a second screen, wherein instructions 503d are provided to write down something about the task.

### Screen 1

Take a small project of your interest and perform the task. While in the process of doing the task, note down the positives you come across.

### Screen 2

Enter the number of positive aspects you noticed today. A box is provided for the user to tap on the correct number.

### Screen 1

Start the hobby which you have stopped because of your commitments. Try to do the activity every day and at the same time note down the positives each day, while you are engaged in that activity.

### Screen 2

Enter the number of positive aspects you experienced today. A box is provided for the user to tap on the correct number.

### Screen 1

Today, start a new activity that you are interested in, which gets completed in short period of time and note down the positive aspects you experience.

### Screen 2

Enter the number of positive aspects you had today. A box is provided for the user to tap on the correct number.

In a fourth level, a list of tasks is sequentially shown one list on a first screen. Each first screen showing a task is followed by a second screen, wherein instructions 503d are provided to write down something about the task.

### Screen 1

Today, pick a task which you feel is important to progress in your career/life. Focus on the positives of the task you are performing and don't give importance to the outcome.

### Screen 2

By the end of the day, please rate your level of discomfort after carrying out this activity (1 being low level of discomfort and 10 being the high level of discomfort). A scale is provided to the user to enter the rating.

In a fifth level, the user is instructed to mentor a person with similar trait with whatever skills the user has learned in the course of this program. This person can be a family member, colleague or a friend.

Referring to FIG. 5E, with regards to ability to take risks 224, real-world activity 510 is used by the activity module 200 based on the brain rewiring 312e, 314e, which the real-world activity 510 is capable of achieving.

The real-world activity 510 may be presented to the user after the user has at least participated in mind actions (410a-410b) a predefined extent that attempts to rewire 312e and 314e the first and second brain wirings 228g and 228h. The real-world activity 510 may be designed to rewire the brain to increase a user's ability to de-amplify the disadvantages of an action in an uncertain situation 312e and to increase a user's ability to weigh between the benefits and disadvantages of an action in an uncertain situation 314e.

In a first level, instructions may be provided to the user to choose a quiet place to sit in and close the eyes and imagine in detail what is shown on a screen. The activity module 200 may show the tasks sequentially to the user.

### Screen 1

Imagine that you are carrying out any thrilling activity. It could be as exciting as deep see diving. Feel the freedom and peace that you will have there. Imagine there is no fear of anything as you are safe and in nature's hand. Imagine how proud you would feel once you completed that activity successfully.
Imagine that you took the position of your favourite actor in a movie that you think is filled with a lot of risks. Feel the happiness and thrill that you would feel, since you are now a part of that situation. Imagine how you can successfully deal with any shortcomings of taking a risk, just like how the actor would.
Imagine a situation in your life where you have to take an important decision. This could be deciding the path of education, getting married or anything relevant in your life. Imagine the happiness that you will feel once you have made the right choice. You will slowly start believing in your ability to take risks. Think about how you will successfully deal with any disadvantages of that decision. It is important to remember that every decision comes with certain advantages and disadvantages.
Imagine that you are an entrepreneur and have a brilliant idea. Feel the excitement you will feel once you follow this dream. Feel the happiness that you will get once your idea succeeds. Imagine that it will not create any negative situation in your life even if takes some time to complete
Imagine about a situation where your loved one has made a secret vacation plan. Feel the excitement and memories that you will get if you accompany him/her. Think about the reasons that will reduce the shortcomings of your secret vacation plan

In a second level, the activity module 200 may choose the tasks to be shown on the screen sequentially and display it to the user.

### Screen 1

In your daily environment, observe those individuals who take risks, which could be for the organization's benefit, entertainment, business purpose, or social cause. Observe how they take risky decision. Count those numbers of people that you see today.
In your daily environment, (Virtual or real) observe those individuals whose new concepts have changed the society and a complete generation. Understand the risk involved in executing the project and how did they do it. Count those numbers of people that you see today.
Pick any movie today in your free time and observe how many times the primary actor takes risks. The Imitation game, A Beautiful mind, Theory of everything, How Einstein came up with E=mc² are a few good examples of movies you could watch.

On a second screen, the user is instructed to enter the number of individuals who filled the above criteria in a box with numbers which the user can tap on, provided by the activity module 200.

In a third level, the activity module 200 may choose the tasks to be shown on the screen sequentially and display it to the user.

### Screen 1:

Consider three risky adventure sports around the world. Find out why people love to do it by searching over internet or asking people who have done it.
Talk to one of your friend who is a risk taker and works in a different company than yours. Ask him about one of the risky decisions he or his company made and why did they do so?
Search for an individual in your organization or in your friend circle who recently talked about entrepreneurship and want to start his own business. Ask him/her about how he/she is progressing and how they will deal with the situation if the venture fails.

On a second screen, the user is instructed to rate the level of learning about risk taking ability (1 being low level of learning and 10 being the high level of learning). A box with numbers may be provided where the user can tap on.

In a fourth level, a list of tasks is sequentially shown one list on a first screen.
Today while going to your office or home or anywhere try finding and taking new route to reach your destination. Talk about your experience with your friends.
Today have dinner or lunch in a restaurant that you don't know about. Try to go there without asking about the ambiance and taste. Bag all your experiences with you while doing this thrilling activity
Buy an item that you have wanted from a place you are not familiar with or give any other item for repair to a new place.

The user may be instructed to rate the level of risk that he is taking (1 being low level risk and 10 being a high-level risk). A scale is presented to the user to provide the rating.

In a fifth level, the activity module 200 may display a task on a screen.
Take a decision in your life which was pending from a long time and which you were afraid to take because of the risk involved in it. Apply all the skills that you have learned while making the decision.

The user may be instructed to rate the level of risk that he is taking (1 being low level risk and 10 being a high-level risk). A scale is presented to the user to provide the rating.

In a sixth level, the user is instructed to mentor a person who is risk averse with whatever skills the user has learned in the course of this program. This person can be a family member, colleague or a friend.

In an embodiment, the action database 206 further includes plurality of physical actions, mind actions and dietary actions, one or more of which may be presented to a user who is trying to improve a positive behavioral trait 214.

Example of physical actions includes one or more physical activities, such as exercises and physical postures, among others. Example of mind actions may include meditation. Example of dietary actions may include adding specific food to one's diet or deleting specific food from the diet. As a further example, drinking black tea may be a dietary action and cutting down on rice consumption may be another dietary action.

### Logging Module 208

In an embodiment, the logging module 208 enables logging of the activities (ex: games, real-world activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the real-world activities and determines scores of each level of real-world activity based on the log that is present in the logging module 208. The assessment module 210 may also determine status of the one or more behavioral trait 214 or the brain wiring to develop the trait 214, after engaging in the activities, based on performance of activities suggested by the activity module 200.

### User Interface Module 212

The user interface module 212 may be configured to receive input from the user and display content to the user. The content displayed, can be, as an example, games, images, instructions, rules, information, haptic feedback and sound, among others.

V. Method for Improving Behavioral Traits that are Required for Achieving Success

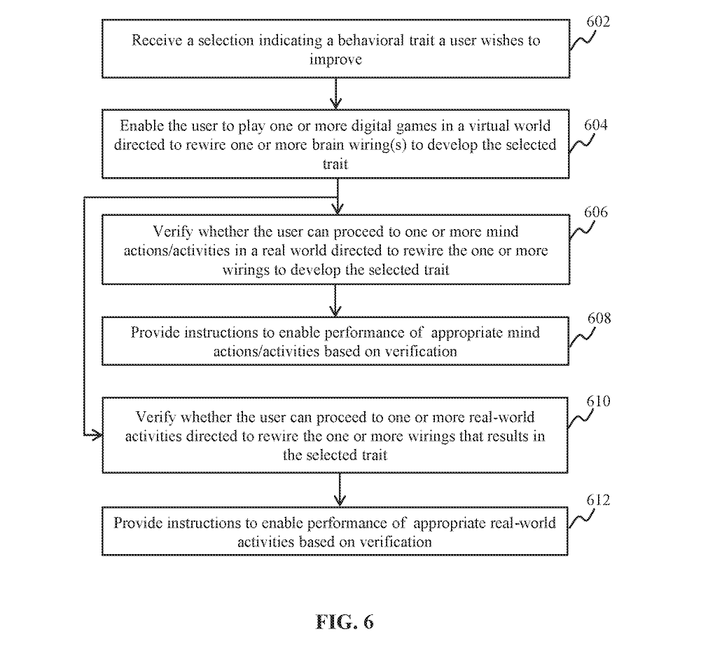

Now referring more particularly to FIG. 6, a method is provided for improve on behavioral traits 214 that are required for achieving success. A selection of a behavioral trait 214, which a user wishes to improve, is received at step 602. The selected trait may be among creativity, ability to network, open-mindedness, passion, and ability to take risks. At step 604, a user is enabled to participate/play in at least one digital game, which is played in a virtual world. The digital game is instrumental in rewiring the brain wiring, whose symptom is exhibition of selected behavioral trait 214. At step 606, verification is made to determine whether the user can proceed to participate in/perform at least one mind action that is instrumental in rewiring a brain wiring, whose symptom is exhibition of selected behavioral trait 214. If it is determined at step 606 that user cannot proceed, then it is established that the user may not be ready for mind actions. On the other hand, if it is determined at step 606 that user can proceed, then at step 608 instructions are provided to the user to enable the user to perform appropriate mind actions/activities. At step 610, verification is made to determine whether the user can proceed to perform real-world activities. In case it is determined at step 610 that user cannot proceed, then it is established that the user may not be ready for real-world activities. On the other hand, if it is determined at step 610 that user can proceed, then at step 612 instructions are provided to the user to enable the user to perform real-world activity/activities. Preferably, the user is allowed to perform or instructed to begin performing appropriate mind actions upon participating in the digital game(s) at least to a predefined extent. Further, the user may be allowed to perform or instructed to begin performing real-world activity/activities upon participating in the mind actions, which is determined based on the desired rewiring. In one or more instances, one or more mind actions, common to more than one rewiring, may be performed upon participating in the real-world activities. The real-world activity/activities are instrumental in rewiring a brain wiring whose symptom is exhibition of said behavioral trait 214.

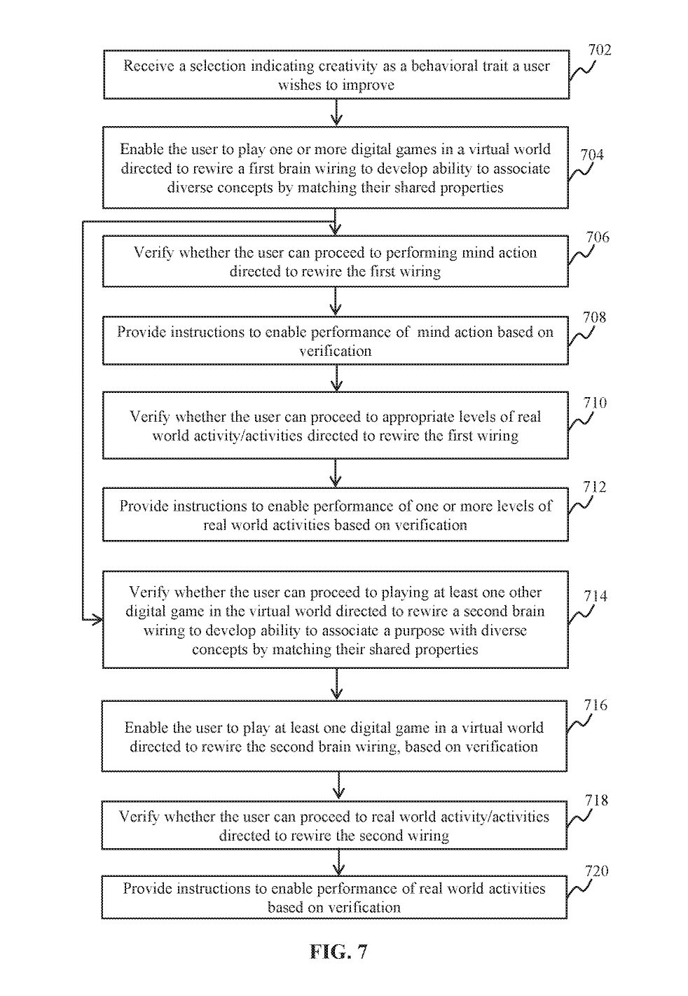

Now referring more particularly to FIG. 7, a method is provided for improving creativity 216. A selection indicating creativity 216, as a behavioral trait, which a user wishes to improve on, is received at step 702. At step 704, a user is enabled to participate/play in one or more digital games 302a-302c, which are played in a virtual world. The digital games 302a, 302b and 302c are instrumental in rewiring 312a, a first brain wiring 228a. At step 706, verification is made whether the user can proceed to performing mind action directed to rewire the first wiring 228a. If it is determined at step 706 that user can proceed, then at step 708 instructions are provided to the user to enable the user to participate in/perform at least one mind action (402). Mind action 402 may be instrumental in rewiring 312a, the first brain wiring 228a. If it is determined at step 706 that user cannot proceed, then it is established that the user may not be ready for mind actions. At step 710, verification is made to determine whether the user can proceed to perform one or more levels of real-world activity 502 that may be used to rewire the first wiring 228a. In case it is determined that user can proceed, then at step 712, instructions are provided to the user to enable the user to perform appropriate levels of real-world activity/activities 502. If it is determined at step 710 that user cannot proceed, then it is established that the user may not be ready for real-world activities. At step 714, verification is made to determine whether the user can proceed to playing one or more other digital games 302d-302f in the virtual world directed to rewire 314a. In case it is determined that user can proceed, then at step 716 the user is enabled to participate/play in one or more of digital games 302d-302f, which are played in a virtual world. At step 718, verification is made to determine whether the user can proceed to perform one or more levels of real-world activities 502. In case it is determined that user can proceed, then at step 720, instructions are provided to the user to enable the user to perform appropriate levels of real-world activity/activities 502.

Referring to the step (702) of receiving a selection indicating creativity 216, the user may be provided an option to select a behavioral trait 214 that he would be like to improve on. The activity module 200 may provide or recommend an option to select at least one behavioral trait to work on. The user may select at least one behavioral trait 214 that the user thinks he needs to work on, from a list of behavioral traits that may be displayed to the user via the user interface module 212. Alternatively, the user may input answers in response to a set of questions displayed to the user, which may determine what type of behavioral trait 214 the user may have. Upon selection of creativity 216, the activity module 200 may display the list 232a of other behavioral traits that can be confused with creativity 216, so that the user can select a more appropriate behavioral trait 214, which he desires to work on. The activity module 200 may further display the information corresponding to the brain wirings 228a, 228b resulting in creativity 216.

The activity module 200 may additionally display information about impact 230a of lack of creativity on the user. In addition, the activity module 200 may display information corresponding to the brain rewiring 312a, 314a that the activity module 200 is attempting to achieve to improve creativity 216. Rewiring 312a results in increased ability to associate diverse concepts by matching their shared properties. Rewiring 314a results in increased ability to associate a purpose with diverse concepts by matching their shared properties.

Referring to the step (704) of enabling the user to play at least one digital game in the virtual world directed to rewire the first brain wiring, the activity module 200 may select one or more digital games based on the capability of the digital games to achieve the desired brain rewiring 312a.

The activity module 200 may provide a choice (one or more games) of games, from which the user may select. The activity module 200 may even indicate the effectiveness of each of the games in achieving the desired brain rewiring 312a or an aspect of rewiring.

In an embodiment, the activity module 200 is configured to recommend a plurality of games, wherein the recommendation indicates each of the games' effectiveness to achieve the desired brain rewiring 312a or an aspect of rewiring.

The activity module 200 allows the user to play the selected game. The logging module 208 may log the performance of the user. The assessment module 210 may determine the performance scores using the log in the logging module 208. Further, based on the respective rules the user is either allowed or denied access to other levels of the games.

Referring to step 706, the activity module 200 verifies whether the user can proceed to perform mind actions/activities. Preferably, the activity module 200 recommends mind actions/activities after the user has performed to a desired extent in the digital game(s). Desired extent of performance can be, as an example, levels completed, score reached and duration over which the game was played. In an embodiment, the activity module 200 recommends (step 708) participating in mind action 402 or a part thereof, after the user has performed to a desired extent in the digital games 302a-302c.

Referring to step 710, the activity module 200 verifies whether the user can proceed to perform real-world activities. Preferably, the activity module 200 recommends real-world activities after the user has performed to a desired extent in the mind games 402. Desired extent of performance can be, as an example, levels completed, score reached and duration over which the game was played.

In an embodiment, the activity module 200 recommends (step 712) participating in one or more levels of real-world activity 502, after the user has performed to a desired extent in the mind action 402.

In an embodiment, the activity module 200 recommends participating in a level or part of real-world activity (ex: level of real-world activity 402a) after the user has performed to a desired extent in a level of the mind action, wherein the mind action prepares the user to participate in the level or part of the real-world activity.

In an embodiment, the activity module 200 is configured to recommend a plurality of real-world activities or sets of real-world activities, wherein the recommendation indicates each of the real-world activities' or sets of real-world activities' effectiveness to achieve the desired brain rewiring.

The logging module 208 may log the performance of the user. The assessment module 210 may determine the performance scores using the log in the logging module 208. Further, based on the rules 249, the user is either allowed or denied access to other levels of the real-world activities or sets of real-world activities.

Referring to step 714, the activity module 200 verifies whether the user can proceed to playing one or more other digital games 302d-302f in the virtual world directed to rewire 314a.

The activity module 200 recommends participating in digital games directed to rewire the second brain wiring after the user has performed to a desired extent in the digital game(s) directed to rewire the first brain wiring. The activity module 200 further recommends participating in digital games directed to rewire the second brain wiring after the user has performed to a desired extent in the digital game(s), the mind action and one or more levels of the real-world activity/activities directed to rewire the first brain wiring 228a.

In an embodiment, the activity module 200 may recommend participating in the real-world activity 502 or a part thereof, after the user has performed to a desired extent in the mind action 402. Desired extent of performance can be, as an example, levels completed, score reached and duration over which the game(s) were played.

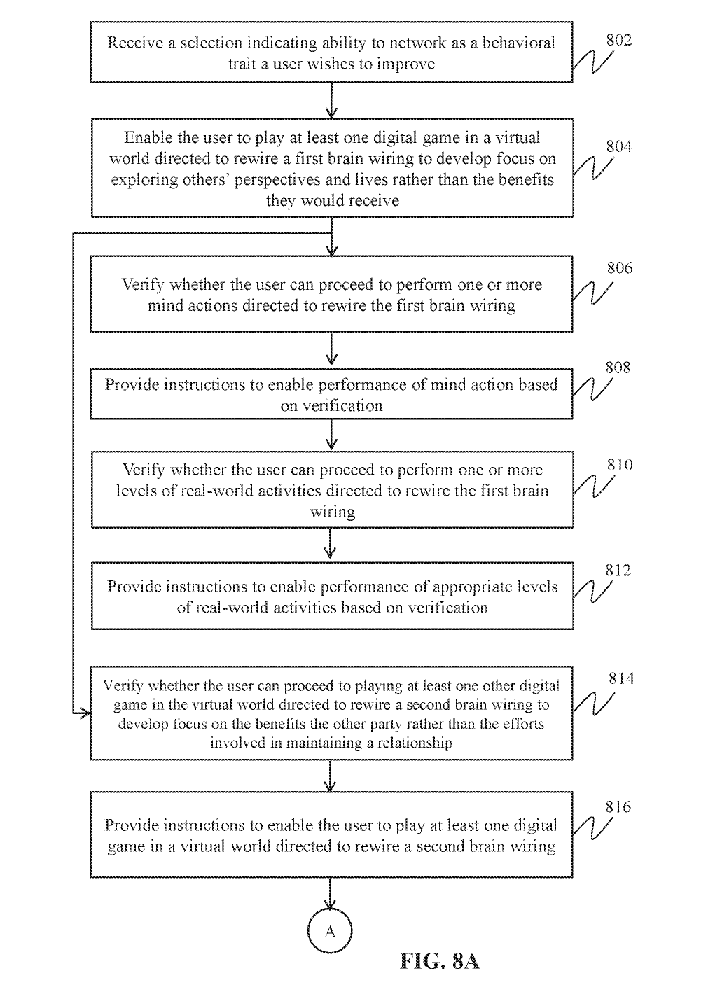

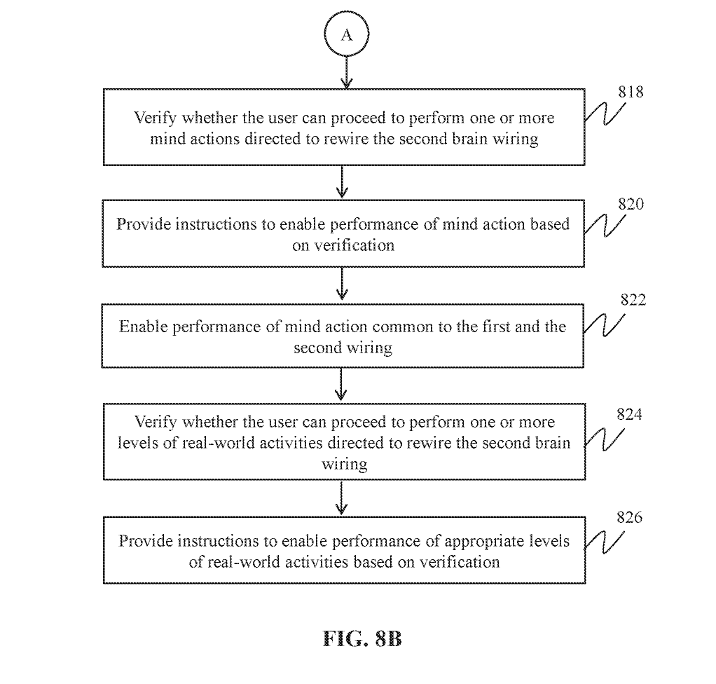

Now referring more particularly to FIGS. 8A-8B, a method is provided for improving ability to network 218. A selection indicating ability to network 218 as a behavioral trait which a user wishes to improve is received at step 802. At step 804, a user is enabled to participate in/play a digital game 304a, which is played in a virtual world. The digital game 304a is instrumental in rewiring 312b the first brain wiring 228c, whose symptom is exhibition of ability to network 218. At step 806, verification is made to determine whether the user can proceed to perform a mind action 404a directed at rewiring 312b the first wiring 228c. Mind action 404a is played in a real-world environment. In case it is determined that the user can proceed, then at step 808, instructions are provided to the user to perform appropriate mind action 404a. At step 810, verification is made to determine whether the user can proceed to perform one or more levels of a real-world activity 504 directed at rewiring 312b the first wiring 228c. In case it is determined that the user can proceed, then at step 812, instructions are provided to the user to perform appropriate levels of real-world activity/activities 504. At step 814, verification is made to determine whether the user can proceed to playing at another digital game 304b in the virtual world directed to rewire the second wiring 228d. In case it is determined that user can proceed, then at step 816 the user is enabled to participate/play in at digital game 304b, which is played in a virtual world. The digital game 304b is instrumental in rewiring 314b the second wiring 228d, whose symptom is exhibition of ability to network 218. At step 818, verification is made to determine whether the user can proceed to perform a mind action 404b that is instrumental in rewiring 314b the second wiring 228d. In case it is determined that user can proceed, then at step 820, instructions are provided to the user to enable the user to perform mind action 404b. Further, at step 822, the activity module 200 enables performance of another mind action to rewire (312b, 314b) the first and the second brain wirings 228c and 228d. At step 824, verification is made to determine whether the user can proceed to perform one or more appropriate levels of real-world activity 504 directed at rewiring second brain wiring 228d. In case it is determined that user can proceed, then at step 826, instructions are provided to the user to enable the user to perform appropriate levels of real-world activity 504.

Upon selection of ability to network 218, the activity module 200 may display the list 232b of other behavioral traits that can be confused with ability to network 218, so that the user can select a more appropriate behavioral trait 214, which he desires to work on. The activity module 200 may further display the information corresponding to the brain wirings 228c, 228d resulting in ability to network 218. Rewiring 312b of the first brain wiring 228c results in increased ability to explore the perspectives and lives of other individuals rather than thinking of their own benefits. Rewiring 314b of the second brain wiring 228d results in increased ability to focus on the benefits of the relationships to the other party rather than the efforts of maintaining a relationship.

Referring to the step (804) of enabling the user to play at least one digital game in the virtual world directed to rewire the first wiring, the activity module 200 may select one or more digital games based on the capability of the digital games to achieve the desired brain rewiring 312b. The activity module 200 may provide a choice (one or more games) of games, from which the user may select. The activity module 200 may even indicate the effectiveness of each of the games in achieving the desired brain rewiring or an aspect of rewiring.

In an embodiment, the activity module 200 is configured to recommend a plurality of games, wherein the recommendation indicates each of the games' effectiveness to achieve the desired brain rewiring or an aspect of rewiring.

Referring to step 806, the activity module 200 verifies whether the user can proceed to perform mind action 404a. Preferably, the activity module 200 recommends mind actions after the user has performed to a desired extent in the digital game 304a. Desired extent of performance can be, as an example, levels completed, score reached and/or duration over which the game was played.

Referring to step 810, the activity module 200 verifies whether the user can proceed to perform appropriate levels of real-world activity 504 that are directed at rewiring the first wiring 228c. Preferably, the activity module 200 recommends appropriate levels of real-world activities after the user has performed to a desired extent in the mind action 404a in a real-world environment.

Referring to step 814, the activity module 200 verifies whether the user can proceed to playing at least one other digital game 304b in the virtual world directed to rewire the second wiring 228d.

The activity module 200 recommends participating in digital game 304b directed to rewire the second wiring 228d after the user has performed to a desired extent in the digital game(s) 304a directed to rewire the first wiring 228c. Alternatively, the activity module 200 recommends participating in digital games directed to rewire the second wiring after the user has performed one or more levels of real-world activity/activities 504 directed to rewire the first wiring 228c.

Referring to step 818, the activity module 200 verifies whether the user can proceed to perform mind action 404b. Preferably, the activity module 200 recommends mind action 404b after the user has performed to a desired extent in the digital game 304a. Desired extent of performance can be, as an example, levels completed, score reached and/or duration over which the game was played.

Referring to step 822, the activity module 200 further recommends mind action 404c to be performed after the user has performed to a desired extent in the mind action 404b. Mind action 404c may be directed at rewiring 312b and 314b the first and the second wirings 228c and 228d.

Referring to step 824, the activity module 200 verifies whether the user can proceed to perform appropriate levels of real-world activity 504 that are directed at rewiring the second wiring 228d. Preferably, the activity module 200 recommends appropriate levels of real-world activity 504 after the user has performed to a desired extent in the mind action 404b in a real-world environment.

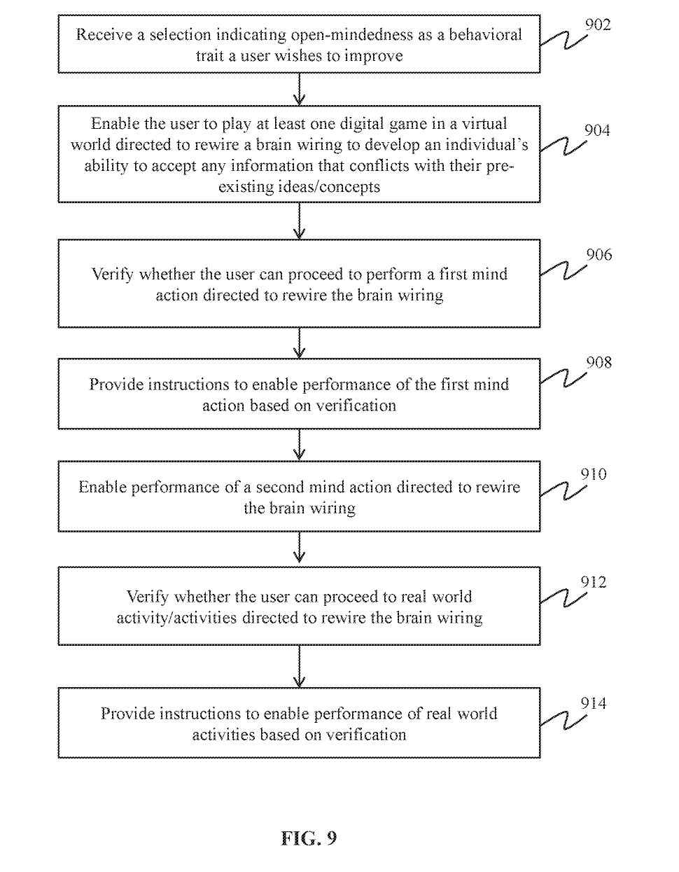

Now referring more particularly to FIG. 9, a method is provided for improving the trait open-mindedness 220. A selection indicating open-mindedness 220 as a behavioral trait, which a user wishes to improve on, is received at step 902. At step 904, a user is enabled to participate/play in at least one digital game 306, which is played in a virtual world. The digital game 306 is instrumental in rewiring 312c the wiring 228e, whose symptom is exhibition of open-mindedness 220. At step 906, verification is made to determine whether the user can proceed to perform a first mind action 406a action directed to rewire the wiring 228e. In case it is determined that the user can proceed to perform the first mind action 406a directed to rewire the brain wiring 228e, then at step 908, instructions are provided to the user to enable the user to perform the mind action 406a. At step 910, the activity module 200 further enables the user to perform a second mind action 406b directed to rewire the wiring 228e. At step 912, verification is made to determine whether the user can proceed to perform the real-world activity/activities 506 directed to rewire the wiring 228e. In case it is determined that the user can proceed to perform real-world activity 506 directed to rewire the wiring, then at step 914, instructions are provided to the user to enable the user to perform appropriate real-world activity 504. The user is allowed to perform or instructed to begin performing real-world activity 506 upon participating in the both the first and the second mind actions 406a and 406b respectively, at least to a predefined extent. Alternatively, the user may be allowed to perform or instructed to begin performing real-world activity 506 upon participating in the first mind action 406a at least to a predefined extent.

Upon selection of open-mindedness 220, the activity module 200 may display the list 232c of other behavioral traits that can be confused with open-mindedness 220, so that the user can select a more appropriate behavioral trait 214, which he desires to work on. The activity module 200 may further display the information corresponding to the brain wiring 228f, resulting in open-mindedness 220. The brain wiring 228e causes an individual to accept any information that conflicts with their pre-existing ideas/concepts.

Referring to the step (904) of enabling the user to play at least one digital game 306 in the virtual world directed to rewire 312c the wiring 228e. The activity module 200 may provide a choice (one or more games) of games, from which the user may select. The activity module 200 may even indicate the effectiveness of each of the games in achieving the desired brain rewiring or an aspect of rewiring. The activity module 200 is configured to recommend a plurality of games, wherein the recommendation indicates each of the games' effectiveness to achieve the desired brain rewiring or an aspect of rewiring.

Referring to step 906, the activity module 200 verifies whether the user can proceed to performing a first mind action 406a. Preferably, the activity module 200 recommends performing the first mind action 406a after the user has performed to a desired extent in the digital game(s) 306. Desired extent of performance can be, as an example, levels completed, score reached and duration over which the game was played. Referring to step 910, the activity module 200 further enables performing the second mind action 406b after the user has performed to a desired extent in the first mind action 406a. Alternatively, the activity module 200 may recommend the second mind action 406b after the user has performed to a desired extent in the real-world activity 506.

Referring to step 912, the activity module 200 verifies whether the user can proceed to performing real-world activity 506. Preferably, the activity module 200 recommends real-world activities 506 after the user has performed to a desired extent in the first and/or the second mind actions 406a and 406b respectively. Desired extent of performance can be, as an example, levels completed, score reached and duration over which the game was played.

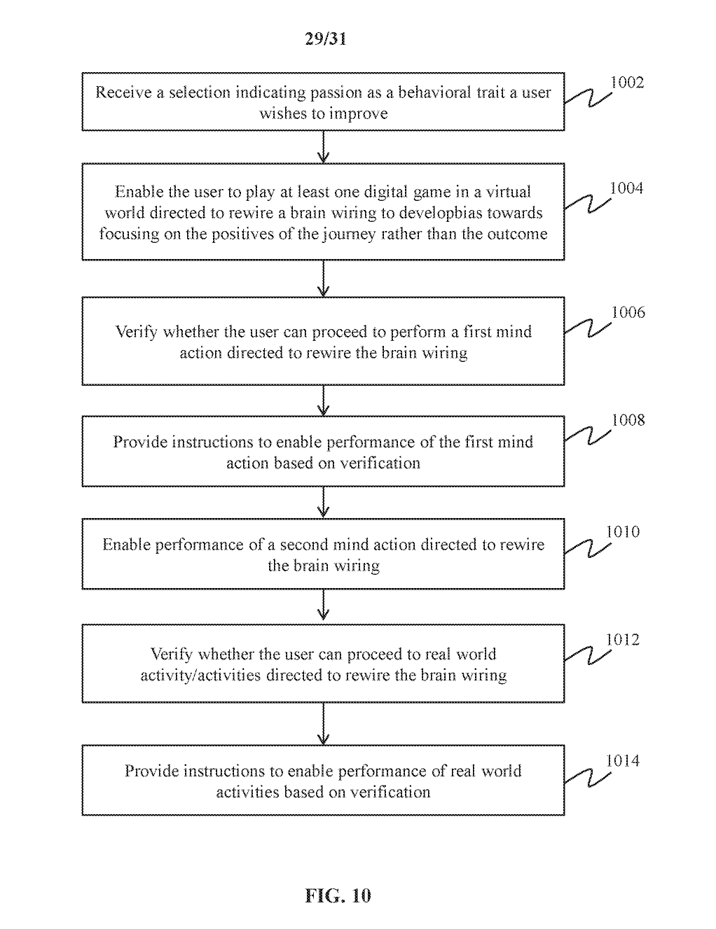

Now referring more particularly to FIG. 10, a method is provided for improving passion 222. A selection indicating passion 222 as a behavioral trait, which a user wishes to improve on, is received at step 1002. At step 1004, a user is enabled to participate/play in at least one digital game 308 which is played in a virtual world. The digital game 308 is instrumental in rewiring 312d the wiring 228f, whose symptom is exhibition of passion 222. At step 1006, verification is made to determine whether the user can proceed to perform a first mind action 408a in a real-world environment, wherein the first mind action 408a is directed at rewiring 312d the wiring 228f. In case it is determined that user can proceed, then at step 1008, instructions are provided to the user to enable the user to perform first mind action 408a. At step 1010, instructions are provided to the user to enable the user to perform a second mind action 408b also directed at rewiring 312d the wiring 228f. At step 1012, verification is made to determine whether the user can proceed to perform real-world activity 508. In case it is determined that user can proceed, then at step 1014, instructions are provided to the user to enable the user to perform the real-world activity 508. Preferably, the user is allowed to perform or instructed to begin performing appropriate real-world activities 508 upon participating in the mind actions 408a and 408b at least to a predefined extent, which is determined based on the desired rewiring.

Upon selection of passion 222, the activity module 200 may display the list 232d of other behavioral traits that can be confused with passion 222, so that the user can select a more appropriate behavioral trait 214, which he desires to work on. The activity module 200 may further display the information corresponding to the brain wiring 228f resulting in passion 222. The brain wiring causes bias towards focusing on the positives of the journey rather than the outcome.

Referring to the step (1004) of enabling the user to play at least one digital game 308 in the virtual world directed to rewire the wiring 228f, the activity module 200 may select one or more digital games based on the capability of the digital games to achieve the desired brain rewiring.

Referring to step 1006, the activity module 200 verifies whether the user can proceed to perform a first mind action 408a. Preferably, the activity module 200 recommends the first mind action 408a after the user has performed to a desired extent in the digital game 308. Desired extent of performance can be, as an example, levels completed, score reached and duration over which the game was played. Referring to step 1010, the activity module 200 verifies whether the user can proceed to perform a second mind action 408b. Preferably, the activity module 200 recommends the second mind action 408b after the user has performed to a desired extent in the first mind action 408a. Alternatively, the activity module 200 may recommend the second mind action 408b after the user has performed to a desired extent in the digital game 308.

Referring to step 1012, the activity module 200 verifies whether the user can proceed to perform real-world activities 508. Preferably, the activity module 200 recommends real-world activity 508 after the user has performed to a desired extent in the mind actions 408a and 408b. Desired extent of performance can be, as an example, levels completed, score reached and duration over which the game was played.

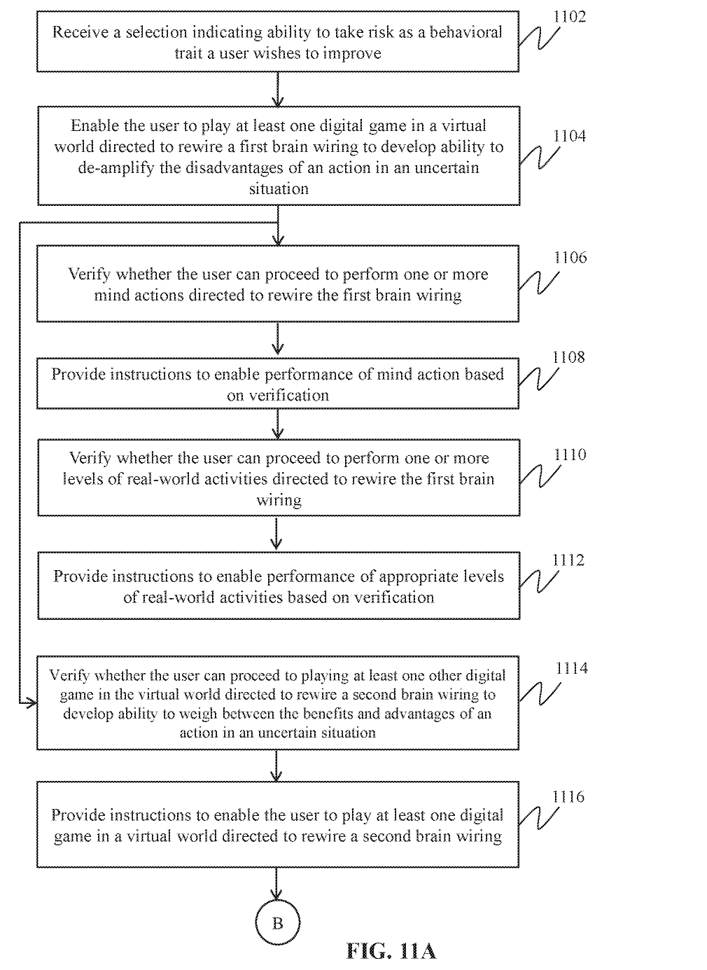

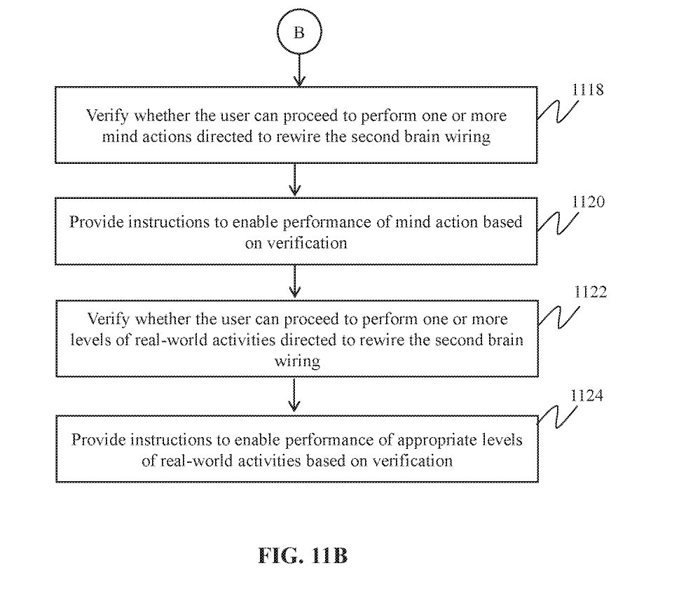

Now referring more particularly to FIGS. 11A and 11B, a method is provided for improving one's ability to take risk 224. A selection indicating ability to take risk 224 as a behavioral trait which a user, wishes to improve on, is received at step 1102. At step 1104, a user is enabled to play/participate in a game 310a, which is played in a virtual world. The digital games 310a is instrumental in rewiring 312e, the first wiring 228g, whose symptom is exhibition of ability to take risk 224. At step 1106, verification is made to determine whether the user can proceed to perform mind action 410a instrumental in rewiring 312e, the first wiring 228g. In case it is determined that user can proceed, then at step 1108, instructions are provided to enable the user to perform mind action 410a. Preferably, the user is allowed to perform or instructed to begin performing mind action 410a upon participating in the digital game 310a at least to a predefined extent, which is determined based on the desired rewiring. At step 1110, verification is made to determine whether the user can proceed to perform appropriate levels of real-world activity 510 instrumental in rewiring 312e. In case it is determined that user can proceed, then at step 1112, instructions are provided to the user to enable the user to perform appropriate levels of real-world activity 510. Preferably, the user is allowed to perform or instructed to begin performing appropriate levels of real-world activity 510 upon participating in the mind action 410a at least to a predefined extent. At step 1114, verification is made to determine whether the user can proceed to playing one other digital games 310b in the virtual world directed to rewire the second wiring 228h. In case it is determined that user can proceed, then at step 1116 the user is enabled to participate/play in the one or more digital games 310b, which is played in a virtual world. The digital game 310b is instrumental in rewiring 314e the second wiring 228h, whose symptom is exhibition of ability to take risk 224. At step 1118, verification is made to determine whether the user can proceed to perform mind action 410b instrumental in rewiring 314e the second wiring 228h. In case it is determined that user can proceed, then at step 1120, instructions are provided to the user to perform mind action 410b. At step 1122, verification is made to determine whether the user can proceed to perform appropriate levels of real-world activity 510 directed at rewiring 314e the second wiring 228h. In case it is determined that user can proceed, then at step 1124, instructions are provided to the user to enable the user to perform appropriate levels of real-world activity 510. Preferably, the user is allowed to perform or instructed to begin performing appropriate levels of real-world activity 510 instrumental in rewiring 314e the second wiring 228h upon participating in the mind action 410b at least to a predefined extent.

Upon selection of ability to take risk 224, the activity module 200 may display the information corresponding to the brain wirings 228g, 228h resulting in the trait ability to take risk 224. The first wiring 228g causes inclination to de-amplify the disadvantages of an action in an uncertain situation. The second wiring 228h causes ability to weigh between the benefits and advantages of an action in an uncertain situation.

Referring to the step (1104) of enabling the user to play one or more digital games in the virtual world directed to rewire the first brain wiring 228g, the activity module 200 may select one or more digital games 310a based on the capability of the digital games to achieve the desired brain rewiring 312e. The activity module 200 may provide a choice (one or more games) of games, from which the user may select. The activity module 200 may even indicate the effectiveness of each of the games in achieving the desired brain rewiring or an aspect of rewiring.

Referring to step 1106, the activity module 200 verifies whether the user can proceed to perform mind action 410a. Preferably, the activity module 200 recommends performing mind action 410a after the user has performed to a desired extent in the digital game(s) 310a. Desired extent of performance can be, as an example, levels completed, score reached and duration over which the game 310a was played.

Referring to step 1110, the activity module 200 verifies whether the user can proceed to perform appropriate levels of real-world activity 510. Preferably, the activity module 200 recommends performing appropriate levels of real-world activity 510 after the user has performed to a desired extent in the mind action 410a.

Referring to step 1114, the activity module 200 verifies whether the user can proceed to playing another digital game 310b in the virtual world directed to rewire the second wiring 228h resulting in ability to weigh between the benefits and advantages of an action in an uncertain situation.

In an embodiment, the activity module 200 recommends participating in digital game 310b directed to rewire the second brain wiring 228h after the user has participated in appropriate levels of real world activity 510 directed to rewire the first wiring 228g. Alternatively, the activity module 200 recommends participating in digital game 310b directed to rewire the second wiring 228h after the user has performed to a desired extent in digital game 310a directed to rewire the first wiring 228g.

Referring to step 1118, the activity module 200 verifies whether the user can proceed to perform mind action 410b directed at rewiring 314e the second wiring 228h. Preferably, the activity module 200 recommends performing mind action 410b after the user has performed to a desired extent in the digital game(s) 310b. Desired extent of performance can be, as an example, levels completed, score reached and duration over which the game 310b was played.

Referring to step 1122, the activity module 200 verifies whether the user can proceed to perform appropriate levels of real-world activity 510 directed at rewiring 314e the second wiring 228h. Preferably, the activity module 200 recommends performing appropriate levels of real-world activity 510 after the user has performed to a desired extent in the mind action 410b.

Additionally, the activity module 200 may provide instruction to perform physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The real-world, mind, physical and dietary activities are carried out in a real environment. Automated instructions are provided as to when and how the activities may have to be carried out. Further, there may be instructions that one or more of the real-world activities may have to be carried out simultaneously with the brain games and one or more of the activities may have to be carried out prior to or after engaging in brain game (digital games) and performing to a desired extent.

In an embodiment, upon selecting a behavioral trait, the activity module 200 provides a scale operable by the user to select a position on the scale. The position may be indicative of the user's perception of the behavioral trait. Improvement in the behavioral trait resulting from the rewiring of the brain achieved by the performance of the activities (virtual games or real-world activities) enabled by the activity module 200 is reflected on the scale. Degradation in the improvement in the behavioral trait resulting from the degradation of the rewiring of the brain due to premature halt in performance of the activities (virtual games or real-world activities) enabled by the activity module 200 is also reflected on the scale.

The games and the real-world activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to improve on behavioral traits that are required for achieving success, the system comprising an activity module configured to:
receive input indicating the desire to improve on behavioral traits among but not limited to creativity, ability to network, open-mindedness, passion and ability to take risk;
enable the user to engage in one or more activities in a virtual environment, wherein the one or more activities affect a wiring of the brain, whose symptom is at least one behavioral trait among creativity, ability to network, open-mindedness, passion and ability to take risk;
enable the user to engage in one or more mind actions, wherein the mind actions affect the wiring of the brain, whose symptom is the behavioral trait among creativity, ability to network, open-mindedness, passion and ability to take risk, wherein engagement in the mind actions is enabled after the user has at least participated in the activities performed in the virtual environment; and
provide automated instructions to the user to engage in at least one real-world activity, wherein the one activity is performed in a real-world environment, wherein the activity affects the wiring of the brain, wherein the activity is performed upon participating in the mind action to a desired extent.

2. The system of claim 1, wherein the activity module is configured to:
receive input indicating the desire to improve on creativity;
enable the user to engage in at least a first activity in a virtual environment, wherein the first activity is directed to rewire a first wiring of the brain resulting in creativity, wherein the first rewiring results in ability to associate diverse concepts by matching their shared properties;
enable the user to engage in at least a second activity in the virtual environment, wherein the second activity is directed to rewire a second wiring of the brain resulting in creativity, wherein the second rewiring results in ability to associate a purpose with diverse concepts by matching their shared properties, wherein symptom of the first and the second rewiring is creativity, wherein engagement in the second activity is enabled after the user has at least participated in the first activity;
enable the user to engage in at least one mind action, wherein the mind action affects the first and second rewiring of the brain, whose symptom is creativity, wherein engagement in the mind action is enabled after the user has at least participated in the first activity performed in the virtual environment; and
provide automated instructions to the user to engage in at least one activity, wherein the one activity is performed in a real-world environment, wherein the activity is directed to rewire the first and the second wiring of the brain resulting in creativity.

3. The system of claim 1, wherein the activity module is configured to:
receive input indicating the desire to improve ability to network;
enable the user to engage in at least a first activity in a virtual environment, wherein the first activity is directed to rewire a first wiring of the brain, wherein the first rewiring results in an individual to focus on exploring others' perspectives and lives rather than the benefits they would receive;
enable the user to engage in at least a second activity in a virtual environment, wherein the second activity is directed to rewire a second wiring of the brain, wherein the second rewiring results in an individual focus on the benefits to the other party rather than the efforts involved in maintaining a relationship;
enable the user to engage in at least a first mind action, wherein the first mind action affects the first rewiring of the brain, whose symptom is ability to network, wherein engagement in the first mind action is enabled after the user has at least participated in the first activity performed in the virtual environment;
enable the user to engage in at least a second mind action, wherein the second mind action affects the second rewiring of the brain, whose symptom is ability to network, wherein engagement in the second mind action is enabled after the user has at least participated in the second activity performed in the virtual environment;
provide automated instructions to the user to engage in at least one activity, wherein the activity is performed in a real-world environment, wherein the activity is directed to rewire the first and the second wirings of the brain;

4. The system of claim 1, wherein the activity module is configured to:
receive input indicating the desire to improve open-mindedness;
enable the user to engage in at least one activity in a virtual environment, wherein the activity is directed to rewire a wiring of the brain resulting in open-mindedness, wherein the rewiring results in accepting any information that conflicts with their pre-existing ideas/concepts;
enable the user to engage in at least a mind action, wherein the mind action affects the rewiring of the brain, whose symptom is open-mindedness, wherein engagement in the first mind action is enabled after the user has at least participated in the activity performed in the virtual environment;
provide automated instructions to the user to engage in at least one activity, wherein the activity is performed in a real-world environment, wherein the activity is directed to rewire the wiring of the brain, whose symptom is open-mindedness;

5. The system of claim 1, wherein the activity module is configured to:
receive input indicating the desire to improve on passion;
enable the user to engage in at least a one activity in a virtual environment, wherein the activity is directed to rewire a wiring of the brain, wherein the rewiring results in bias towards focusing on the positives of the journey rather than the outcome;
enable the user to engage in at least a mind action, wherein the mind action affects the rewiring of the brain, whose symptom is passion, wherein engagement in mind action is enabled after the user has at least participated in the activity performed in the virtual environment;
provide automated instructions to the user to engage in at least one activity, wherein the one activity is performed in a real-world environment, wherein the activity is directed to rewire the wiring of the brain, whose symptom is passion, wherein the activity is performed in a real-world environment;

6. The system of claim 1, wherein the activity module is configured to:
receive input indicating the desire to improve ability to take risk;
enable the user to engage in at least a first activity in a virtual environment, wherein the first activity is directed to rewire a first wiring of the brain, wherein the first rewiring results in ability to de-amplify the disadvantages of an action in an uncertain situation;
enable the user to engage in at least a second activity in the virtual environment, wherein the second activity is directed to rewire a second wiring of the brain, wherein the second rewiring results in ability to weigh between the benefits and advantages of an action in an uncertain situation, wherein symptom of the first and the second wirings is ability to take risk;
enable the user to engage in at least a first mind action, wherein the first mind action affects the first rewiring of the brain, whose symptom is ability to take risk, wherein engagement in the first mind action is enabled after the user has at least participated in the first activity performed in the virtual environment;
enable the user to engage in at least a second mind action, wherein the second mind action affects the second rewiring of the brain, whose symptom is ability to take risk, wherein engagement in the second mind action is enabled after the user has at least participated in the second activity performed in the virtual environment; and
provide automated instructions to the user to engage in at least one activity, wherein the one activity is performed in a real-world environment, wherein the activity is directed to rewire the first and the second wirings of the brain, whose symptom is ability to take risk.

7. The system according to claim 1, wherein the activities in the virtual environment are digital games.

8. The system of claim 7, wherein,
at least one of the digital games comprises a plurality of levels;
a higher level in the digital game is unlocked based on predefined criteria; and
the higher level is unlocked upon repeatedly playing a previous level in the digital game for a predefined number of times or duration of time.

9. The system of claim 1, wherein activity module is further configured to:
provide a choice comprising a plurality of activities to engage in the virtual environment, wherein each of the plurality of activities is directed at rewiring the wiring of the brain.

10. The system according to claim 1, wherein the activity module is further configured to indicate effectiveness of each of the plurality of activities to engage in the virtual environment, in achieving desired rewiring of the brain.

11. The system according to claim 1, wherein the activity module is further configured to:
recommend activities among the plurality of activities to engage in the virtual environment, wherein the recommendation indicates each of the activities' effectiveness to achieve desired rewiring of the brain.

12. The system of claim 1, wherein the activity module is further configured to:
provide instructions to the user to engage in the mind actions, which affects the wirings of the brain, after the user has engaged in the activities in the virtual environment to a predefined extent.

13. The system according to claim 12, wherein the predefined extent is based on desired rewiring of the brain.

14. The system of claim 1, wherein the activity module is further configured to:
provide the automated instructions to the user to engage in the activities in the real-world, which affects the rewiring of the brain, after the user has engaged in the mind actions in the real-world to a predefined extent.

15. The system according to claim 14, wherein the predefined extent is based on desired rewiring of the wirings of the brain.

16. The system of claim 1, wherein the activity module is further configured to:
provide the automated instructions to the user to engage in the one activity in the real-world, which affects the wirings of the brain, after the user has engaged in the mind actions in the real-world environment.

17. The system according to claim 1, wherein the activity module is further configured to provides instructions to engage in dietary and physical activities.

18. The system according to claim 1, wherein the activity module is further configured to:
provide a scale operable by the user to select a position on the scale, wherein the position is indicative of the user's perception of the behavioral trait;
reflect on the scale improvement in the behavioral trait resulting from rewiring of the first and second wirings; and
reflect on the scale degradation of the improvement in the behavioral trait resulting from degradation of the rewiring due to premature halt in performance of the activities in the virtual environment and the real-world environment.

19. A method for enabling a user to improve on behavioral traits that are required for achieving success, the method comprising:
enabling the user to engage in one or more activity in a virtual environment, wherein the one or more activities affect one or more rewiring of the brain, whose symptom is a behavioral trait required for achieving success;
enabling the user to engage in at least one or more mind actions, wherein the mind actions affect the one or more rewiring of the brain, whose symptom is a behavioral trait required for achieving success, wherein engagement in the mind actions is enabled after the user has at least participated in the activities in the virtual world;
providing automated instructions to the user to engage in at least one activity, wherein the one activity is performed in a real-world environment, wherein the activity affects the one or more rewiring of the brain.

20. The method according to claim 19, wherein,
the instructions to the user to engage in the mind actions, which affects the rewiring of the brain, is provided after the user has engaged in the activity in the virtual environment to a predefined extent.

21. The method according to claim 19, wherein,
the automated instructions to the user to engage in the activities in the real-world, which affects the rewiring of the brain, is provided after the user has engaged in the mind action in the real-world to a predefined extent.

22. A system for enabling a user to improve on behavioral traits that are required for achieving success, the system comprising an activity module configured to:
receive input indicating the desire to improve on behavioral traits among creativity, ability to network, open-mindedness, passion and ability to take risk;
if the input indicates the desire to improve on creativity, then:
enable the user to engage in at least a first activity in a virtual environment, wherein the first activity is directed to rewire a first wiring of the brain resulting in creativity, to increase the ability of users to associate diverse concepts by matching their shared properties;
enable the user to engage in at least a second activity in the virtual environment, wherein the second activity is directed to rewire a second wiring of the brain resulting in creativity, to increase the ability to associate a purpose with diverse concepts by matching their shared properties;
enable the user to engage in at least a mind action, wherein the mind action affects the first rewiring of the brain, wherein engagement in the mind action is enabled after the user has at least participated in the first activity performed in the virtual environment; and
provide automated instructions to the user to engage in at least one activity, wherein the one activity is performed in a real-world environment, wherein the activity is directed to rewire the first and the second wiring of the brain resulting in creativity;
if the input indicates the desire to improve on ability to network, then:
enable the user to engage in at least a first activity in a virtual environment, wherein the first activity is directed to rewire a first wiring of the brain, resulting in ability to network, to increase focus on exploring others' perspectives and lives rather than the benefits they would receive;
enable the user to engage in at least a second activity in a virtual environment, wherein the second activity is directed to rewire a second wiring of the brain, resulting in ability to network, to increase focus on the benefits to the other party rather than the efforts involved in maintaining a relationship;
enable the user to engage in at least a first mind action, wherein the first mind action affects the first rewiring of the brain, wherein engagement in the first mind action is enabled after the user has at least participated in the first activity performed in the virtual environment;
enable the user to engage in at least a second mind action, wherein the second mind action affects the second rewiring of the brain, wherein engagement in the second mind action is enabled after the user has at least participated in the second activity performed in the virtual environment; and
provide automated instructions to the user to engage in at least one activity, wherein the one activity is performed in a real-world environment, wherein the activity is directed to rewire the first and the second wirings of the brain;
if the input indicates the desire to improve on open-mindedness, then:
enable the user to engage in at least one activity in a virtual environment, wherein the activity is directed to rewire a wiring of the brain resulting in open-mindedness, to enable users to accept any information that conflicts with their pre-existing ideas/concepts;
enable the user to engage in at least a mind action, wherein the mind action affects the rewiring of the brain, wherein engagement in the mind action is enabled after the user has at least participated in the activity performed in the virtual environment;
provide automated instructions to the user to engage in at least one activity, wherein the one activity is performed in a real-world environment, wherein the activity is directed to rewire the wiring of the brain, whose symptom is open-mindedness;
if the input indicates the desire to improve on passion, then:
enable the user to engage in at least a one activity in a virtual environment, wherein the activity is directed to rewire a wiring of the brain, resulting in passion, to enable users to focus on the positives of the journey rather than the outcome;
enable the user to engage in at least a mind action, wherein the mind action affects the wiring of the brain, wherein engagement in the mind action is enabled after the user has at least participated in the activity performed in the virtual environment;
provide automated instructions to the user to engage in at least one activity, wherein the one activity is performed in a real-world environment, wherein the activity is directed to rewire the wiring of the brain, wherein the activity is performed in a real-world environment; and
if the input indicates the desire to improve on ability to take risk, then:
enable the user to engage in at least a first activity in a virtual environment, wherein the first activity is directed to rewire a first wiring of the brain, resulting in ability to take risk, to increase ability to de amplify the disadvantages of an action in an uncertain situation;
enable the user to engage in at least a second activity in the virtual environment, wherein the second activity is directed to rewire a second wiring of the brain, resulting in ability to take risk, to increase ability to weigh between the benefits and disadvantages of an action in an uncertain situation;
enable the user to engage in at least a first mind action, wherein the first mind action affects the first wiring of the brain, wherein engagement in the first mind action is enabled after the user has at least participated in the first activity performed in the virtual environment;
enable the user to engage in at least a second mind action, wherein the second mind action affects the second wiring of the brain, wherein engagement in the second mind action is enabled after the user has at least participated in the second activity performed in the virtual environment; and
provide automated instructions to the user to engage in at least one activity, wherein the one activity is performed in a real-world environment, wherein the activity is directed to rewire the first and second wirings of the brain.
